(19) United States
(12) Patent Application Publication
(10) Pub. No.: US 2019/0195788 A1
(43) Pub. Date: Jun. 27, 2019

(54) WHEEL-MOUNTED FIELD SENSING

(71) Applicant: The Climate Corporation, San Francisco, CA (US)

(72) Inventors: MIAO LIU, Wildwood, MO (US); LOUIS JOHN MEYER, Creve Coeur, MO (US)

(21) Appl. No.: 15/851,209

(22) Filed: Dec. 21, 2017

(51) Int. Cl. G01N 21/3563; G01N 21/33; G05B 19/418; G06F 17/50; G06Q 50/02; H04L 29/08

(52) U.S. Cl. CPC G01N 21/3563; G01N 21/33; G05B 19/41845; G01N 2033/245; G06Q 50/02; H04L 67/125; G06F 17/50

(57) ABSTRACT

In an embodiment, an apparatus for sensing soil characteristics comprises a circular wheel frame that is capable of rotation in an agricultural field; at least one first arcuate tread segment that is affixed to an outer rim of the wheel frame and constitutes a soil contacting bearing surface when the apparatus is in contact with soil; at least one recess in the outer rim of the wheel frame; a circuit board within the wheel frame and having at least a first receptacle that is radially aligned with the at least one recesses; at least one removable sensor comprising one or more first sensing elements, a first plug that mates to the first receptacle of the circuit board, and a second arcuate tread segment and configured to mount in the at least one recess with the second arcuate tread segment aligned with the first arcuate tread segment to form a continuous tread; a power supply coupled to the at least one removable sensor through the connector; means coupled to the power supply for wirelessly transmitting data obtained from the at least one removable sensor to a host computer that is separate from the apparatus.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright or rights whatsoever. © 2015-2017 The Climate Corporation.

### FIELD OF THE DISCLOSURE

The present disclosure is in the technical field of agricultural sensors. The disclosure also relates to the technical field of soil sensing and internet of things (IoT) devices as applied to agriculture.

### BACKGROUND

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

Agriculture can achieve greater crop yield per field unit (acre or hectare) when soil conditions, soil chemistry, and soil moisture content are well managed. To facilitate smart field management, frequent measurements of soil chemicals and soil moisture are necessary. While indirect measurements using satellite imagery and aircraft surveys are possible, direct measurement in a particular field may provide better data. However, direct measurement of field soils typically is time-consuming and inefficient. Past approaches have included walking in fields to obtain soil samples, driving tractors or trucks in fields to different locations to obtain soil samples, or other manual dedicated testing methods. These approaches lack efficiency because they are not integrated with other actions that require entering a field, such as tilling, seeding, fertilizing or harvesting.

### SUMMARY

The appended claims may serve as a summary of the disclosure.

### BRIEF DESCRIPTION OF THE DRAWINGS

In the drawings:

FIG. 1 illustrates an example computer system that is configured to perform the functions described herein, shown in a field environment with other apparatus with which the system may interoperate.

FIG. 2 illustrates in two views denoted (a), (b) example logical organizations of sets of instructions in main memory when an example mobile application is loaded for execution.

FIG. 3 illustrates a programmed process by which the agricultural intelligence computer system generates one or more preconfigured agronomic models using agronomic data provided by one or more data sources.

FIG. 4 is a block diagram that illustrates a computer system upon which an embodiment of the invention may be implemented.

FIG. 5 depicts an example embodiment of a timeline view for data entry.

FIG. 6 depicts an example embodiment of a spreadsheet view for data entry.

FIG. 7 illustrates a sensor wheel according to a first mounting arrangement.

FIG. 8 illustrates a sensor wheel according to a second mounting arrangement.

FIG. 9 illustrates a sensor wheel according to a third mounting arrangement.

FIG. 10 is an exploded perspective view of a sensor wheel in a partly disassembled state.

FIG. 11 illustrates a bottom plan view of a wheel in an embodiment similar to that seen in FIG. 10 and showing details of an underside of a circuit board and related components.

FIG. 12 is a perspective view of a circuit board in an embodiment that is similar to the circuit board of FIG. 11.

FIG. 13 is a top perspective view of an example sensor.

FIG. 14 is a bottom perspective view of the example sensor of FIG. 13.

FIG. 15 is a bottom plan view of a sensor wheel in another embodiment with a cover removed and showing an opposite orientation from FIG. 11.

FIG. 16A is a schematic illustration of elements of a sensor.

FIG. 16B illustrates light paths of an optical sensor in relation to a furrow in soil.

FIG. 17 is a schematic diagram of circuitry that may be used within a soil-contacting wheel having a plurality of removable sensors, in one embodiment.

### DETAILED DESCRIPTION

In the following description, for the purposes of explanation, numerous specific details are set forth in order to provide a thorough understanding of the present disclosure. It will be apparent, however, that embodiments may be practiced without these specific details. In other instances, well-known structures and devices are shown in block diagram form in order to avoid unnecessarily obscuring the present disclosure. Embodiments are disclosed in sections according to the following outline:

1. GENERAL OVERVIEW

2. EXAMPLE AGRICULTURAL INTELLIGENCE COMPUTER SYSTEM

2.1. STRUCTURAL OVERVIEW

2.2. APPLICATION PROGRAM OVERVIEW

2.3. DATA INGEST TO THE COMPUTER SYSTEM

2.4. PROCESS OVERVIEW—AGRONOMIC MODEL TRAINING

2.5. IMPLEMENTATION EXAMPLE—HARDWARE OVERVIEW

3. EXAMPLE SENSOR WHEEL

1. General Overview

In an embodiment, an apparatus for sensing soil characteristics comprises a circular wheel frame that is capable of rotation in an agricultural field; at least one first arcuate tread segment that is affixed to an outer rim of the wheel frame and constitutes a soil contacting bearing surface when the apparatus is in contact with soil; at least one recess in the outer rim of the wheel frame; a circuit board within the wheel frame and having at least a first receptacle that is radially aligned with the at least one recesses; at least one removable sensor comprising one or more first sensing elements, a first plug that mates to the first receptacle of the circuit board, and a second arcuate tread segment and configured to mount in the at least one recess with the second arcuate tread segment aligned with the first arcuate tread segment to form a continuous tread; a power supply coupled to the at least one removable sensor through the connector; means coupled to the power supply for wirelessly transmitting data obtained from the at least one removable sensor to a host computer that is separate from the apparatus.

In another embodiment, a computer system for sensing soil characteristics comprises a multi-sensor wheel comprising a circular wheel frame that is capable of rotation in an agricultural field; at least one first arcuate tread segment that is affixed to an outer rim of the wheel frame and constitutes a soil contacting bearing surface when the apparatus is in contact with soil; at least one recess in the outer rim of the wheel frame; a circuit board within the wheel frame and having at least a first receptacle that is radially aligned with the at least one recesses; at least one removable sensor comprising one or more first sensing elements, a first plug that mates to the first receptacle of the circuit board, and a second arcuate tread segment and configured to mount in the at least one recess with the second arcuate tread segment aligned with the first arcuate tread segment to form a continuous tread; at least a second removable sensor comprising one or more second sensing elements, a second plug that mates to a second receptacle of the circuit board, and a third arcuate tread segment and configured to mount in a second recess of the wheel frame with the third arcuate tread segment aligned with the first arcuate tread segment to form a continuous tread; wherein the first sensing elements and the second sensing elements are configured to sense different characteristics of soil; a power supply coupled to the at least one removable sensor through the connector; and means coupled to the power supply for wirelessly transmitting sensor data obtained from the at least one removable sensor; a host computer that is separate from the apparatus and configured to wirelessly connect to the multi-sensor wheel and to receive the sensor data.

In an embodiment, a sensor wheel having a plurality of removable sensors provides a flexible data collection platform for obtaining sensor data that permits characterizing field conditions for farmers. In an embodiment, a sensor wheel is structured for mounting on multiple different kinds of farm equipment, for example planters, harvesters or spray systems. In an embodiment, the sensors are modular and interchangeable. Therefore, a grower who is focused on characterizing moisture may use three or four moisture sensors, or could use a moisture sensor, a soil firmness sensor, an organic matter sensor and a temperature sensor concurrently mounted in the same wheel. Sensors may be mounted or changed depending on the particular need of a specific grower to characterize their field.

In an embodiment, the sensor wheel comprises a central processing unit (CPU) that is configured and programmed to automatically identify what sensors are installed, to obtain raw data from each sensor in operation, and to wirelessly transmit the data to a separate computer system. The separate computer system may be a local host computer such as a laptop or desktop computer that is proximate to the wheel when mounted or dismounted, such as a tractor cab computer, or the separate computer may comprise a cloud computing instance that receives data through a networked uploading operation, or a combination thereof. Data obtained from direct field measurements in this manner may be integrated with other data using server computer-based applications or cloud-based applications. The foregoing operations may be performed as other agricultural operations are carried out in the field and data may be uploaded or transferred from the wheel to another computer immediately or promptly after the data is obtained.

2. Example Agricultural Intelligence Computer System

2.1 Structural Overview

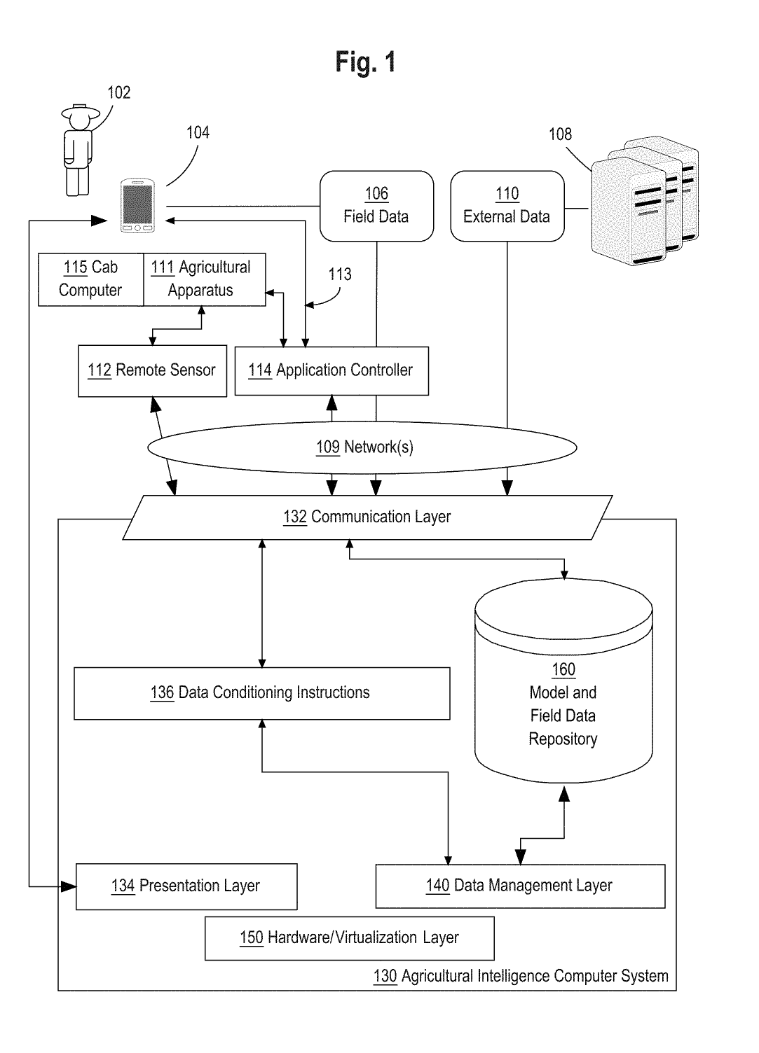

FIG. 1 illustrates an example computer system that is configured to perform the functions described herein, shown in a field environment with other apparatus with which the system may interoperate. In one embodiment, a user 102 owns, operates or possesses a field manager computing device 104 in a field location or associated with a field location such as a field intended for agricultural activities or a management location for one or more agricultural fields. The field manager computer device 104 is programmed or configured to provide field data 106 to an agricultural intelligence computer system 130 via one or more networks 109.

Examples of field data 106 include (a) identification data (for example, acreage, field name, field identifiers, geographic identifiers, boundary identifiers, crop identifiers, and any other suitable data that may be used to identify farm land, such as a common land unit (CLU), lot and block number, a parcel number, geographic coordinates and boundaries, Farm Serial Number (FSN), farm number, tract number, field number, section, township, and/or range), (b) harvest data (for example, crop type, crop variety, crop rotation, whether the crop is grown organically, harvest date, Actual Production History (APH), expected yield, yield, crop price, crop revenue, grain moisture, tillage practice, and previous growing season information), (c) soil data (for example, type, composition, pH, organic matter (OM), cation exchange capacity (CEC)), (d) planting data (for example, planting date, seed(s) type, relative maturity (RM) of planted seed(s), seed population), (e) fertilizer data (for example, nutrient type (Nitrogen, Phosphorous, Potassium), application type, application date, amount, source, method), (f) chemical application data (for example, pesticide, herbicide, fungicide, other substance or mixture of substances intended for use as a plant regulator, defoliant, or desiccant, application date, amount, source, method), (g) irrigation data (for example, application date, amount, source, method), (h) weather data (for example, precipitation, rainfall rate, predicted rainfall, water runoff rate region, temperature, wind, forecast, pressure, visibility, clouds, heat index, dew point, humidity, snow depth, air quality, sunrise, sunset), (i) imagery data (for example, imagery and light spectrum information from an agricultural apparatus sensor, camera, computer, smartphone, tablet, unmanned aerial vehicle, planes or satellite), (j) scouting observations (photos, videos, free form notes, voice recordings, voice transcriptions, weather conditions (temperature, precipitation (current and over time), soil moisture, crop growth stage, wind velocity, relative humidity, dew point, black layer)), and (k) soil, seed, crop phenology, pest and disease reporting, and predictions sources and databases.

A data server computer 108 is communicatively coupled to agricultural intelligence computer system 130 and is programmed or configured to send external data 110 to agricultural intelligence computer system 130 via the network(s) 109. The external data server computer 108 may be owned or operated by the same legal person or entity as the agricultural intelligence computer system 130, or by a different person or entity such as a government agency, non-governmental organization (NGO), and/or a private data service provider. Examples of external data include weather data, imagery data, soil data, or statistical data relating to crop yields, among others. External data 110 may consist of the same type of information as field data 106. In some embodiments, the external data 110 is provided by an external data server 108 owned by the same entity that owns and/or operates the agricultural intelligence computer system 130. For example, the agricultural intelligence computer system 130 may include a data server focused exclusively on a type of data that might otherwise be obtained from third party sources, such as weather data. In some embodiments, an external data server 108 may actually be incorporated within the system 130.

An agricultural apparatus 111 may have one or more remote sensors 112 fixed thereon, which sensors are communicatively coupled either directly or indirectly via agricultural apparatus 111 to the agricultural intelligence computer system 130 and are programmed or configured to send sensor data to agricultural intelligence computer system 130. Examples of agricultural apparatus 111 include tractors, combines, harvesters, planters, trucks, fertilizer equipment, aerial vehicles including unmanned aerial vehicles, and any other item of physical machinery or hardware, typically mobile machinery, and which may be used in tasks associated with agriculture. In some embodiments, a single unit of apparatus 111 may comprise a plurality of sensors 112 that are coupled locally in a network on the apparatus; controller area network (CAN) is example of such a network that can be installed in combines, harvesters, sprayers, and cultivators. Application controller 114 is communicatively coupled to agricultural intelligence computer system 130 via the network(s) 109 and is programmed or configured to receive one or more scripts that are used to control an operating parameter of an agricultural vehicle or implement from the agricultural intelligence computer system 130. For instance, a controller area network (CAN) bus interface may be used to enable communications from the agricultural intelligence computer system 130 to the agricultural apparatus 111, such as how the CLIMATE FIELDVIEW DRIVE, available from The Climate Corporation, San Francisco, Calif., is used. Sensor data may consist of the same type of information as field data 106. In some embodiments, remote sensors 112 may not be fixed to an agricultural apparatus 111 but may be remotely located in the field and may communicate with network 109.

The apparatus 111 may comprise a cab computer 115 that is programmed with a cab application, which may comprise a version or variant of the mobile application for device 104 that is further described in other sections herein. In an embodiment, cab computer 115 comprises a compact computer, often a tablet-sized computer or smartphone, with a graphical screen display, such as a color display, that is mounted within an operator's cab of the apparatus 111. Cab computer 115 may implement some or all of the operations and functions that are described further herein for the mobile computer device 104.

The network(s) 109 broadly represent any combination of one or more data communication networks including local area networks, wide area networks, internetworks or internets, using any of wireline or wireless links, including terrestrial or satellite links. The network(s) may be implemented by any medium or mechanism that provides for the exchange of data between the various elements of FIG. 1. The various elements of FIG. 1 may also have direct (wired or wireless) communications links. The sensors 112, controller 114, external data server computer 108, and other elements of the system each comprise an interface compatible with the network(s) 109 and are programmed or configured to use standardized protocols for communication across the networks such as TCP/IP, Bluetooth, CAN protocol and higher-layer protocols such as HTTP, TLS, and the like.

Agricultural intelligence computer system 130 is programmed or configured to receive field data 106 from field manager computing device 104, external data 110 from external data server computer 108, and sensor data from remote sensor 112. Agricultural intelligence computer system 130 may be further configured to host, use or execute one or more computer programs, other software elements, digitally programmed logic such as FPGAs or ASICs, or any combination thereof to perform translation and storage of data values, construction of digital models of one or more crops on one or more fields, generation of recommendations and notifications, and generation and sending of scripts to application controller 114, in the manner described further in other sections of this disclosure.

In an embodiment, agricultural intelligence computer system 130 is programmed with or comprises a communication layer 132, presentation layer 134, data management layer 140, hardware/virtualization layer 150, and model and field data repository 160. “Layer,” in this context, refers to any combination of electronic digital interface circuits, microcontrollers, firmware such as drivers, and/or computer programs or other software elements.

Communication layer 132 may be programmed or configured to perform input/output interfacing functions including sending requests to field manager computing device 104, external data server computer 108, and remote sensor 112 for field data, external data, and sensor data respectively. Communication layer 132 may be programmed or configured to send the received data to model and field data repository 160 to be stored as field data 106.

Presentation layer 134 may be programmed or configured to generate a graphical user interface (GUI) to be displayed on field manager computing device 104, cab computer 115 or other computers that are coupled to the system 130 through the network 109. The GUI may comprise controls for inputting data to be sent to agricultural intelligence computer system 130, generating requests for models and/or recommendations, and/or displaying recommendations, notifications, models, and other field data.

Data management layer 140 may be programmed or configured to manage read operations and write operations involving the repository 160 and other functional elements of the system, including queries and result sets communicated between the functional elements of the system and the repository. Examples of data management layer 140 include JDBC, SQL server interface code, and/or HADOOP interface code, among others. Repository 160 may comprise a database. As used herein, the term “database” may refer to either a body of data, a relational database management system (RDBMS), or to both. As used herein, a database may comprise any collection of data including hierarchical databases, relational databases, flat file databases, object-relational databases, object oriented databases, distributed databases, and any other structured collection of records or data that is stored in a computer system. Examples of RDBMS's include, but are not limited to including, ORACLE®, MYSQL, IBM® DB2, MICROSOFT® SQL SERVER, SYBASE®, and POSTGRESQL databases. However, any database may be used that enables the systems and methods described herein.

When field data 106 is not provided directly to the agricultural intelligence computer system via one or more agricultural machines or agricultural machine devices that interacts with the agricultural intelligence computer system, the user may be prompted via one or more user interfaces on the user device (served by the agricultural intelligence computer system) to input such information. In an example embodiment, the user may specify identification data by accessing a map on the user device (served by the agricultural intelligence computer system) and selecting specific CLUs that have been graphically shown on the map. In an alternative embodiment, the user 102 may specify identification data by accessing a map on the user device (served by the agricultural intelligence computer system 130) and drawing boundaries of the field over the map. Such CLU selection or map drawings represent geographic identifiers. In alternative embodiments, the user may specify identification data by accessing field identification data (provided as shape files or in a similar format) from the U. S. Department of Agriculture Farm Service Agency or other source via the user device and providing such field identification data to the agricultural intelligence computer system.

In an example embodiment, the agricultural intelligence computer system 130 is programmed to generate and cause displaying a graphical user interface comprising a data manager for data input. After one or more fields have been identified using the methods described above, the data manager may provide one or more graphical user interface widgets which when selected can identify changes to the field, soil, crops, tillage, or nutrient practices. The data manager may include a timeline view, a spreadsheet view, and/or one or more editable programs.

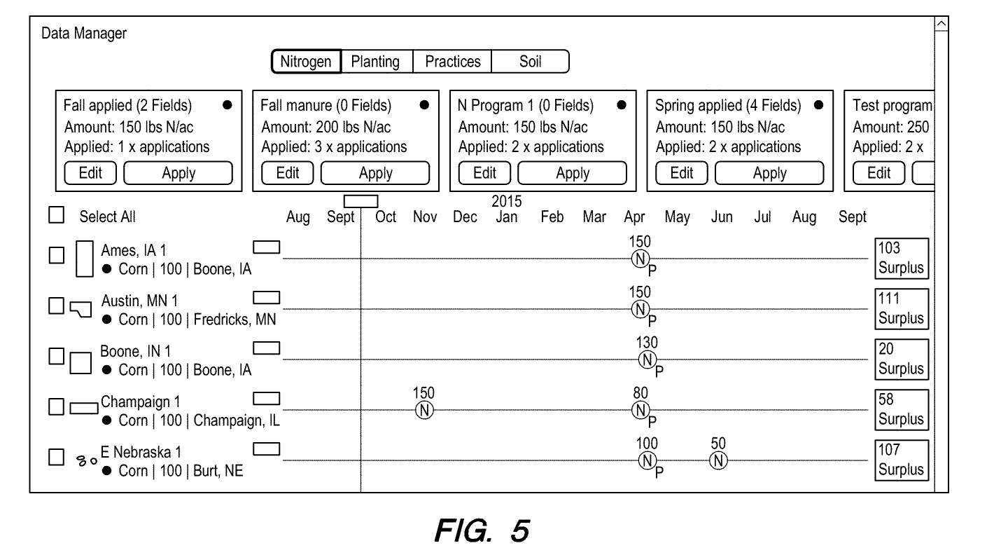

FIG. 5 depicts an example embodiment of a timeline view for data entry. Using the display depicted in FIG. 5, a user computer can input a selection of a particular field and a particular date for the addition of event. Events depicted at the top of the timeline may include Nitrogen, Planting, Practices, and Soil. To add a nitrogen application event, a user computer may provide input to select the nitrogen tab. The user computer may then select a location on the timeline for a particular field in order to indicate an application of nitrogen on the selected field. In response to receiving a selection of a location on the timeline for a particular field, the data manager may display a data entry overlay, allowing the user computer to input data pertaining to nitrogen applications, planting procedures, soil application, tillage procedures, irrigation practices, or other information relating to the particular field. For example, if a user computer selects a portion of the timeline and indicates an application of nitrogen, then the data entry overlay may include fields for inputting an amount of nitrogen applied, a date of application, a type of fertilizer used, and any other information related to the application of nitrogen.

In an embodiment, the data manager provides an interface for creating one or more programs. “Program,” in this context, refers to a set of data pertaining to nitrogen applications, planting procedures, soil application, tillage procedures, irrigation practices, or other information that may be related to one or more fields, and that can be stored in digital data storage for reuse as a set in other operations. After a program has been created, it may be conceptually applied to one or more fields and references to the program may be stored in digital storage in association with data identifying the fields. Thus, instead of manually entering identical data relating to the same nitrogen applications for multiple different fields, a user computer may create a program that indicates a particular application of nitrogen and then apply the program to multiple different fields. For example, in the timeline view of FIG. 5, the top two timelines have the “Spring applied” program selected, which includes an application of 150 lbs N/ac in early April. The data manager may provide an interface for editing a program. In an embodiment, when a particular program is edited, each field that has selected the particular program is edited. For example, in FIG. 5, if the “Spring applied” program is edited to reduce the application of nitrogen to 130 lbs N/ac, the top two fields may be updated with a reduced application of nitrogen based on the edited program.

In an embodiment, in response to receiving edits to a field that has a program selected, the data manager removes the correspondence of the field to the selected program. For example, if a nitrogen application is added to the top field in FIG. 5, the interface may update to indicate that the “Spring applied” program is no longer being applied to the top field. While the nitrogen application in early April may remain, updates to the “Spring applied” program would not alter the April application of nitrogen.

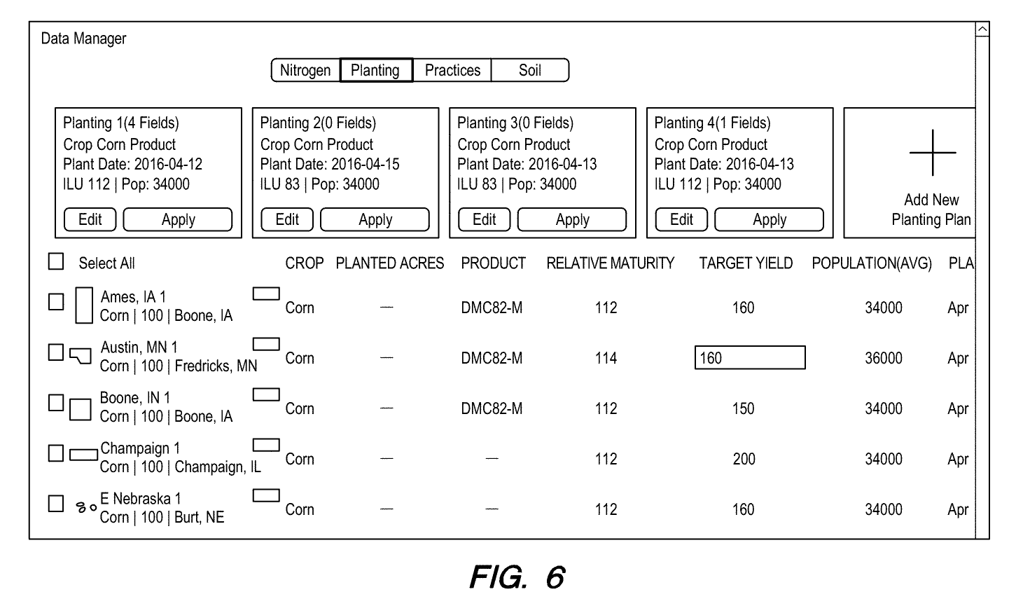

FIG. 6 depicts an example embodiment of a spreadsheet view for data entry. Using the display depicted in FIG. 6, a user can create and edit information for one or more fields. The data manager may include spreadsheets for inputting information with respect to Nitrogen, Planting, Practices, and Soil as depicted in FIG. 6. To edit a particular entry, a user computer may select the particular entry in the spreadsheet and update the values. For example, FIG. 6 depicts an in-progress update to a target yield value for the second field. Additionally, a user computer may select one or more fields in order to apply one or more programs. In response to receiving a selection of a program for a particular field, the data manager may automatically complete the entries for the particular field based on the selected program. As with the timeline view, the data manager may update the entries for each field associated with a particular program in response to receiving an update to the program. Additionally, the data manager may remove the correspondence of the selected program to the field in response to receiving an edit to one of the entries for the field.

In an embodiment, model and field data is stored in model and field data repository 160. Model data comprises data models created for one or more fields. For example, a crop model may include a digitally constructed model of the development of a crop on the one or more fields. “Model,” in this context, refers to an electronic digitally stored set of executable instructions and data values, associated with one another, which are capable of receiving and responding to a programmatic or other digital call, invocation, or request for resolution based upon specified input values, to yield one or more stored or calculated output values that can serve as the basis of computer-implemented recommendations, output data displays, or machine control, among other things. Persons of skill in the field find it convenient to express models using mathematical equations, but that form of expression does not confine the models disclosed herein to abstract concepts; instead, each model herein has a practical application in a computer in the form of stored executable instructions and data that implement the model using the computer. The model may include a model of past events on the one or more fields, a model of the current status of the one or more fields, and/or a model of predicted events on the one or more fields. Model and field data may be stored in data structures in memory, rows in a database table, in flat files or spreadsheets, or other forms of stored digital data.

In an embodiment, data conditioning instructions 136 comprises a set of one or more pages of main memory, such as RAM, in the agricultural intelligence computer system 130 into which executable instructions have been loaded and which when executed cause the agricultural intelligence computing system to perform the functions or operations that are described herein with reference to those modules. For example, the data conditioning instructions 136 may comprise a set of pages in RAM that contain instructions which when executed cause performing obtaining raw sensor data from a sensor wheel 700 as further described herein, filtering or transforming the data to remove noise, anomalies or outlier values, and updating repository 160 with filtered or improved data from the sensor wheel. The instructions may be in machine executable code in the instruction set of a CPU and may have been compiled based upon source code written in JAVA, C, C++, OBJECTIVE-C, or any other human-readable programming language or environment, alone or in combination with scripts in JAVASCRIPT, other scripting languages and other programming source text. The term “pages” is intended to refer broadly to any region within main memory and the specific terminology used in a system may vary depending on the memory architecture or processor architecture. In another embodiment, the data conditioning instructions 136 also may represent one or more files or projects of source code that are digitally stored in a mass storage device such as non-volatile RAM or disk storage, in the agricultural intelligence computer system 130 or a separate repository system, which when compiled or interpreted cause generating executable instructions which when executed cause the agricultural intelligence computing system to perform the functions or operations that are described herein with reference to those modules. In other words, the drawing figure may represent the manner in which programmers or software developers organize and arrange source code for later compilation into an executable, or interpretation into bytecode or the equivalent, for execution by the agricultural intelligence computer system 130.

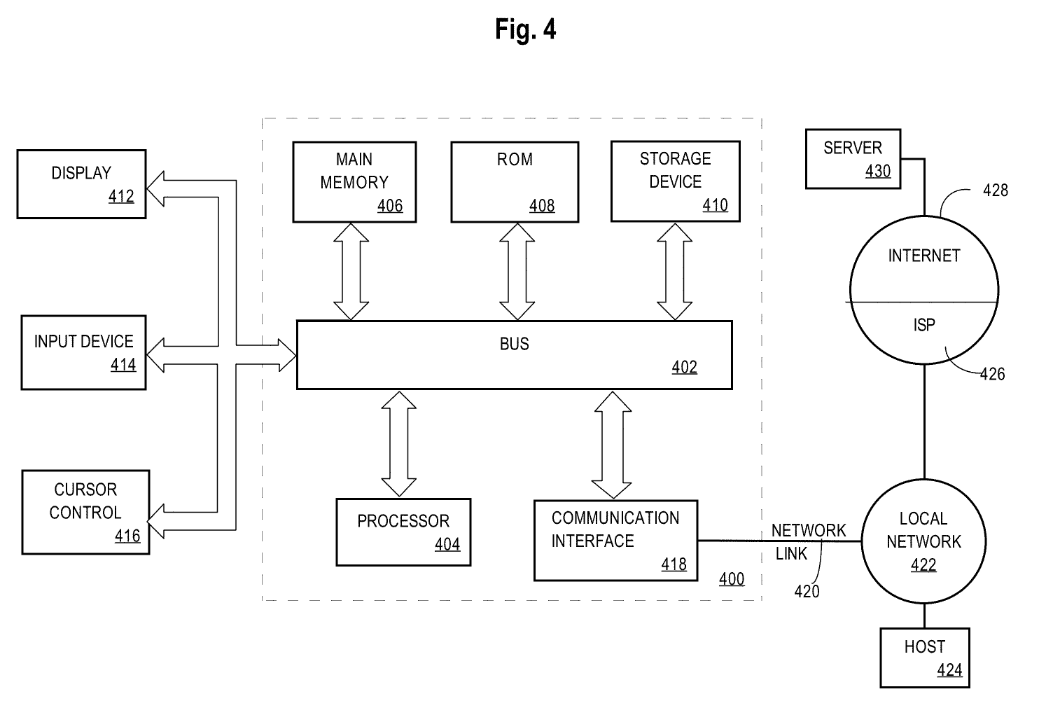

Hardware/virtualization layer 150 comprises one or more central processing units (CPUs), memory controllers, and other devices, components, or elements of a computer system such as volatile or non-volatile memory, non-volatile storage such as disk, and I/O devices or interfaces as illustrated and described, for example, in connection with FIG. 4. The layer 150 also may comprise programmed instructions that are configured to support virtualization, containerization, or other technologies.

For purposes of illustrating a clear example, FIG. 1 shows a limited number of instances of certain functional elements. However, in other embodiments, there may be any number of such elements. For example, embodiments may use thousands or millions of different mobile computing devices 104 associated with different users. Further, the system 130 and/or external data server computer 108 may be implemented using two or more processors, cores, clusters, or instances of physical machines or virtual machines, configured in a discrete location or co-located with other elements in a datacenter, shared computing facility or cloud computing facility.

2.2. Application Program Overview

In an embodiment, the implementation of the functions described herein using one or more computer programs or other software elements that are loaded into and executed using one or more general-purpose computers will cause the general-purpose computers to be configured as a particular machine or as a computer that is specially adapted to perform the functions described herein. Further, each of the flow diagrams that are described further herein may serve, alone or in combination with the descriptions of processes and functions in prose herein, as algorithms, plans or directions that may be used to program a computer or logic to implement the functions that are described. In other words, all the prose text herein, and all the drawing figures, together are intended to provide disclosure of algorithms, plans or directions that are sufficient to permit a skilled person to program a computer to perform the functions that are described herein, in combination with the skill and knowledge of such a person given the level of skill that is appropriate for inventions and disclosures of this type.

In an embodiment, user 102 interacts with agricultural intelligence computer system 130 using field manager computing device 104 configured with an operating system and one or more application programs or apps; the field manager computing device 104 also may interoperate with the agricultural intelligence computer system independently and automatically under program control or logical control and direct user interaction is not always required. Field manager computing device 104 broadly represents one or more of a smart phone, PDA, tablet computing device, laptop computer, desktop computer, workstation, or any other computing device capable of transmitting and receiving information and performing the functions described herein. Field manager computing device 104 may communicate via a network using a mobile application stored on field manager computing device 104, and in some embodiments, the device may be coupled using a cable 113 or connector to the sensor 112 and/or controller 114. A particular user 102 may own, operate or possess and use, in connection with system 130, more than one field manager computing device 104 at a time.

The mobile application may provide client-side functionality, via the network to one or more mobile computing devices. In an example embodiment, field manager computing device 104 may access the mobile application via a web browser or a local client application or app. Field manager computing device 104 may transmit data to, and receive data from, one or more front-end servers, using web-based protocols or formats such as HTTP, XML and/or JSON, or app-specific protocols. In an example embodiment, the data may take the form of requests and user information input, such as field data, into the mobile computing device. In some embodiments, the mobile application interacts with location tracking hardware and software on field manager computing device 104 which determines the location of field manager computing device 104 using standard tracking techniques such as multilateration of radio signals, the global positioning system (GPS), WiFi positioning systems, or other methods of mobile positioning. In some cases, location data or other data associated with the device 104, user 102, and/or user account(s) may be obtained by queries to an operating system of the device or by requesting an app on the device to obtain data from the operating system.

In an embodiment, field manager computing device 104 sends field data 106 to agricultural intelligence computer system 130 comprising or including, but not limited to, data values representing one or more of: a geographical location of the one or more fields, tillage information for the one or more fields, crops planted in the one or more fields, and soil data extracted from the one or more fields. Field manager computing device 104 may send field data 106 in response to user input from user 102 specifying the data values for the one or more fields. Additionally, field manager computing device 104 may automatically send field data 106 when one or more of the data values becomes available to field manager computing device 104. For example, field manager computing device 104 may be communicatively coupled to remote sensor 112 and/or application controller 114 which include an irrigation sensor and/or irrigation controller. In response to receiving data indicating that application controller 114 released water onto the one or more fields, field manager computing device 104 may send field data 106 to agricultural intelligence computer system 130 indicating that water was released on the one or more fields. Field data 106 identified in this disclosure may be input and communicated using electronic digital data that is communicated between computing devices using parameterized URLs over HTTP, or another suitable communication or messaging protocol.

A commercial example of the mobile application is CLIMATE FIELDVIEW, commercially available from The Climate Corporation, San Francisco, Calif. The CLIMATE FIELDVIEW application, or other applications, may be modified, extended, or adapted to include features, functions, and programming that have not been disclosed earlier than the filing date of this disclosure. In one embodiment, the mobile application comprises an integrated software platform that allows a grower to make fact-based decisions for their operation because it combines historical data about the grower's fields with any other data that the grower wishes to compare. The combinations and comparisons may be performed in real time and are based upon scientific models that provide potential scenarios to permit the grower to make better, more informed decisions.

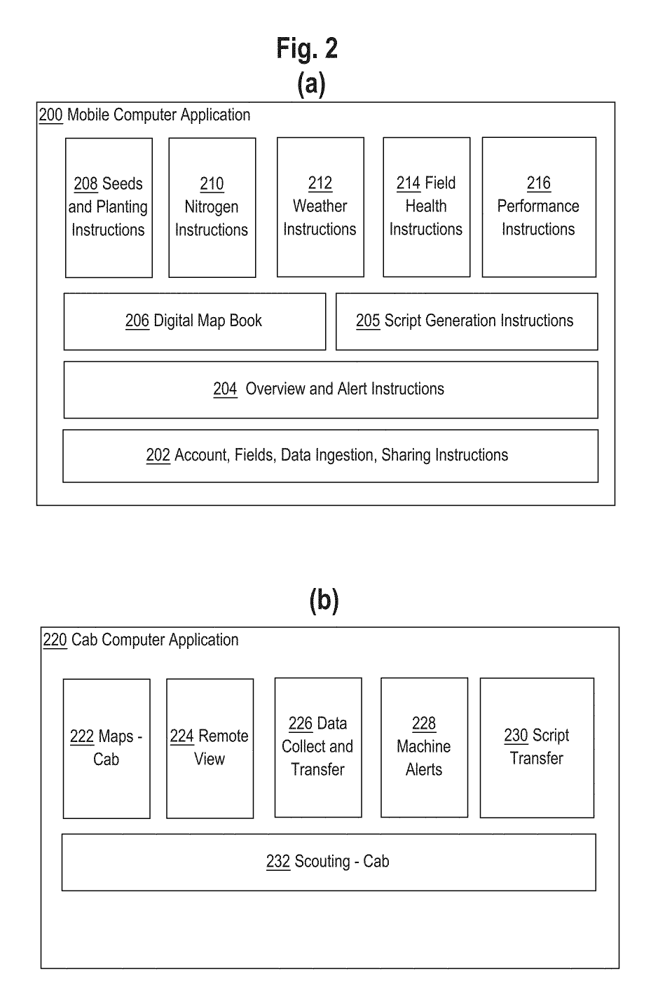

FIG. 2 illustrates two views of an example logical organization of sets of instructions in main memory when an example mobile application is loaded for execution. In FIG. 2, each named element represents a region of one or more pages of RAM or other main memory, or one or more blocks of disk storage or other non-volatile storage, and the programmed instructions within those regions. In one embodiment, in view (a), a mobile computer application 200 comprises account-fields-data ingestion-sharing instructions 202, overview and alert instructions 204, digital map book instructions 206, seeds and planting instructions 208, nitrogen instructions 210, weather instructions 212, field health instructions 214, and performance instructions 216.

In one embodiment, a mobile computer application 200 comprises account, fields, data ingestion, sharing instructions 202 which are programmed to receive, translate, and ingest field data from third party systems via manual upload or APIs. Data types may include field boundaries, yield maps, as-planted maps, soil test results, as-applied maps, and/or management zones, among others. Data formats may include shape files, native data formats of third parties, and/or farm management information system (FMIS) exports, among others. Receiving data may occur via manual upload, e-mail with attachment, external APIs that push data to the mobile application, or instructions that call APIs of external systems to pull data into the mobile application. In one embodiment, mobile computer application 200 comprises a data inbox. In response to receiving a selection of the data inbox, the mobile computer application 200 may display a graphical user interface for manually uploading data files and importing uploaded files to a data manager.

In one embodiment, digital map book instructions 206 comprise field map data layers stored in device memory and are programmed with data visualization tools and geospatial field notes. This provides growers with convenient information close at hand for reference, logging and visual insights into field performance. In one embodiment, overview and alert instructions 204 are programmed to provide an operation-wide view of what is important to the grower, and timely recommendations to take action or focus on particular issues. This permits the grower to focus time on what needs attention, to save time and preserve yield throughout the season. In one embodiment, seeds and planting instructions 208 are programmed to provide tools for seed selection, hybrid placement, and script creation, including variable rate (VR) script creation, based upon scientific models and empirical data. This enables growers to maximize yield or return on investment through optimized seed purchase, placement and population.

In one embodiment, script generation instructions 205 are programmed to provide an interface for generating scripts, including variable rate (VR) fertility scripts. The interface enables growers to create scripts for field implements, such as nutrient applications, planting, and irrigation. For example, a planting script interface may comprise tools for identifying a type of seed for planting. Upon receiving a selection of the seed type, mobile computer application 200 may display one or more fields broken into management zones, such as the field map data layers created as part of digital map book instructions 206. In one embodiment, the management zones comprise soil zones along with a panel identifying each soil zone and a soil name, texture, drainage for each zone, or other field data. Mobile computer application 200 may also display tools for editing or creating such, such as graphical tools for drawing management zones, such as soil zones, over a map of one or more fields. Planting procedures may be applied to all management zones or different planting procedures may be applied to different subsets of management zones. When a script is created, mobile computer application 200 may make the script available for download in a format readable by an application controller, such as an archived or compressed format. Additionally, and/or alternatively, a script may be sent directly to cab computer 115 from mobile computer application 200 and/or uploaded to one or more data servers and stored for further use.

In one embodiment, nitrogen instructions 210 are programmed to provide tools to inform nitrogen decisions by visualizing the availability of nitrogen to crops. This enables growers to maximize yield or return on investment through optimized nitrogen application during the season. Example programmed functions include displaying images such as SSURGO images to enable drawing of fertilizer application zones and/or images generated from subfield soil data, such as data obtained from sensors, at a high spatial resolution (as fine as millimeters or smaller depending on sensor proximity and resolution); upload of existing grower-defined zones; providing a graph of plant nutrient availability and/or a map to enable tuning application(s) of nitrogen across multiple zones; output of scripts to drive machinery; tools for mass data entry and adjustment; and/or maps for data visualization, among others. “Mass data entry,” in this context, may mean entering data once and then applying the same data to multiple fields and/or zones that have been defined in the system; example data may include nitrogen application data that is the same for many fields and/or zones of the same grower, but such mass data entry applies to the entry of any type of field data into the mobile computer application 200. For example, nitrogen instructions 210 may be programmed to accept definitions of nitrogen application and practices programs and to accept user input specifying to apply those programs across multiple fields. “Nitrogen application programs,” in this context, refers to stored, named sets of data that associates: a name, color code or other identifier, one or more dates of application, types of material or product for each of the dates and amounts, method of application or incorporation such as injected or broadcast, and/or amounts or rates of application for each of the dates, crop or hybrid that is the subject of the application, among others. “Nitrogen practices programs,” in this context, refer to stored, named sets of data that associates: a practices name; a previous crop; a tillage system; a date of primarily tillage; one or more previous tillage systems that were used; one or more indicators of application type, such as manure, that were used. Nitrogen instructions 210 also may be programmed to generate and cause displaying a nitrogen graph, which indicates projections of plant use of the specified nitrogen and whether a surplus or shortfall is predicted; in some embodiments, different color indicators may signal a magnitude of surplus or magnitude of shortfall. In one embodiment, a nitrogen graph comprises a graphical display in a computer display device comprising a plurality of rows, each row associated with and identifying a field; data specifying what crop is planted in the field, the field size, the field location, and a graphic representation of the field perimeter; in each row, a timeline by month with graphic indicators specifying each nitrogen application and amount at points correlated to month names; and numeric and/or colored indicators of surplus or shortfall, in which color indicates magnitude.

In one embodiment, the nitrogen graph may include one or more user input features, such as dials or slider bars, to dynamically change the nitrogen planting and practices programs so that a user may optimize his nitrogen graph. The user may then use his optimized nitrogen graph and the related nitrogen planting and practices programs to implement one or more scripts, including variable rate (VR) fertility scripts. Nitrogen instructions 210 also may be programmed to generate and cause displaying a nitrogen map, which indicates projections of plant use of the specified nitrogen and whether a surplus or shortfall is predicted; in some embodiments, different color indicators may signal a magnitude of surplus or magnitude of shortfall. The nitrogen map may display projections of plant use of the specified nitrogen and whether a surplus or shortfall is predicted for different times in the past and the future (such as daily, weekly, monthly or yearly) using numeric and/or colored indicators of surplus or shortfall, in which color indicates magnitude. In one embodiment, the nitrogen map may include one or more user input features, such as dials or slider bars, to dynamically change the nitrogen planting and practices programs so that a user may optimize his nitrogen map, such as to obtain a preferred amount of surplus to shortfall. The user may then use his optimized nitrogen map and the related nitrogen planting and practices programs to implement one or more scripts, including variable rate (VR) fertility scripts. In other embodiments, similar instructions to the nitrogen instructions 210 could be used for application of other nutrients (such as phosphorus and potassium), application of pesticide, and irrigation programs.

In one embodiment, weather instructions 212 are programmed to provide field-specific recent weather data and forecasted weather information. This enables growers to save time and have an efficient integrated display with respect to daily operational decisions.

In one embodiment, field health instructions 214 are programmed to provide timely remote sensing images highlighting in-season crop variation and potential concerns. Example programmed functions include cloud checking, to identify possible clouds or cloud shadows; determining nitrogen indices based on field images; graphical visualization of scouting layers, including, for example, those related to field health, and viewing and/or sharing of scouting notes; and/or downloading satellite images from multiple sources and prioritizing the images for the grower, among others.

In one embodiment, performance instructions 216 are programmed to provide reports, analysis, and insight tools using on-farm data for evaluation, insights and decisions. This enables the grower to seek improved outcomes for the next year through fact-based conclusions about why return on investment was at prior levels, and insight into yield-limiting factors. The performance instructions 216 may be programmed to communicate via the network(s) 109 to back-end analytics programs executed at agricultural intelligence computer system 130 and/or external data server computer 108 and configured to analyze metrics such as yield, yield differential, hybrid, population, SSURGO zone, soil test properties, or elevation, among others. Programmed reports and analysis may include yield variability analysis, treatment effect estimation, benchmarking of yield and other metrics against other growers based on anonymized data collected from many growers, or data for seeds and planting, among others.

Applications having instructions configured in this way may be implemented for different computing device platforms while retaining the same general user interface appearance. For example, the mobile application may be programmed for execution on tablets, smartphones, or server computers that are accessed using browsers at client computers. Further, the mobile application as configured for tablet computers or smartphones may provide a full app experience or a cab app experience that is suitable for the display and processing capabilities of cab computer 115. For example, referring now to view (b) of FIG. 2, in one embodiment a cab computer application 220 may comprise maps-cab instructions 222, remote view instructions 224, data collect and transfer instructions 226, machine alerts instructions 228, script transfer instructions 230, and scouting-cab instructions 232. The code base for the instructions of view (b) may be the same as for view (a) and executables implementing the code may be programmed to detect the type of platform on which they are executing and to expose, through a graphical user interface, only those functions that are appropriate to a cab platform or full platform. This approach enables the system to recognize the distinctly different user experience that is appropriate for an in-cab environment and the different technology environment of the cab. The maps-cab instructions 222 may be programmed to provide map views of fields, farms or regions that are useful in directing machine operation. The remote view instructions 224 may be programmed to turn on, manage, and provide views of machine activity in real-time or near real-time to other computing devices connected to the system 130 via wireless networks, wired connectors or adapters, and the like. The data collect and transfer instructions 226 may be programmed to turn on, manage, and provide transfer of data collected at sensors and controllers to the system 130 via wireless networks, wired connectors or adapters, and the like. The machine alerts instructions 228 may be programmed to detect issues with operations of the machine or tools that are associated with the cab and generate operator alerts. The script transfer instructions 230 may be configured to transfer in scripts of instructions that are configured to direct machine operations or the collection of data. The scouting-cab instructions 232 may be programmed to display location-based alerts and information received from the system 130 based on the location of the field manager computing device 104, agricultural apparatus 111, or sensors 112 in the field and ingest, manage, and provide transfer of location-based scouting observations to the system 130 based on the location of the agricultural apparatus 111 or sensors 112 in the field.

2.3. Data Ingest to the Computer System

In an embodiment, external data server computer 108 stores external data 110, including soil data representing soil composition for the one or more fields and weather data representing temperature and precipitation on the one or more fields. The weather data may include past and present weather data as well as forecasts for future weather data. In an embodiment, external data server computer 108 comprises a plurality of servers hosted by different entities. For example, a first server may contain soil composition data while a second server may include weather data. Additionally, soil composition data may be stored in multiple servers. For example, one server may store data representing percentage of sand, silt, and clay in the soil while a second server may store data representing percentage of organic matter (OM) in the soil.

In an embodiment, remote sensor 112 comprises one or more sensors that are programmed or configured to produce one or more observations. Remote sensor 112 may be aerial sensors, such as satellites, vehicle sensors, planting equipment sensors, tillage sensors, fertilizer or insecticide application sensors, harvester sensors, and any other implement capable of receiving data from the one or more fields. In an embodiment, application controller 114 is programmed or configured to receive instructions from agricultural intelligence computer system 130. Application controller 114 may also be programmed or configured to control an operating parameter of an agricultural vehicle or implement. For example, an application controller may be programmed or configured to control an operating parameter of a vehicle, such as a tractor, planting equipment, tillage equipment, fertilizer or insecticide equipment, harvester equipment, or other farm implements such as a water valve. Other embodiments may use any combination of sensors and controllers, of which the following are merely selected examples.

The system 130 may obtain or ingest data under user 102 control, on a mass basis from a large number of growers who have contributed data to a shared database system. This form of obtaining data may be termed “manual data ingest” as one or more user-controlled computer operations are requested or triggered to obtain data for use by the system 130. As an example, the CLIMATE FIELDVIEW application, commercially available from The Climate Corporation, San Francisco, Calif., may be operated to export data to system 130 for storing in the repository 160.

For example, seed monitor systems can both control planter apparatus components and obtain planting data, including signals from seed sensors via a signal harness that comprises a CAN backbone and point-to-point connections for registration and/or diagnostics. Seed monitor systems can be programmed or configured to display seed spacing, population and other information to the user via the cab computer 115 or other devices within the system 130. Examples are disclosed in U.S. Pat. No. 8,738,243 and US Pat. Pub. 20150094916, and the present disclosure assumes knowledge of those other patent disclosures.

Likewise, yield monitor systems may contain yield sensors for harvester apparatus that send yield measurement data to the cab computer 115 or other devices within the system 130. Yield monitor systems may utilize one or more remote sensors 112 to obtain grain moisture measurements in a combine or other harvester and transmit these measurements to the user via the cab computer 115 or other devices within the system 130.

In an embodiment, examples of sensors 112 that may be used with any moving vehicle or apparatus of the type described elsewhere herein include kinematic sensors and position sensors. Kinematic sensors may comprise any of speed sensors such as radar or wheel speed sensors, accelerometers, or gyros. Position sensors may comprise GPS receivers or transceivers, or WiFi-based position or mapping apps that are programmed to determine location based upon nearby WiFi hotspots, among others.

In an embodiment, examples of sensors 112 that may be used with tractors or other moving vehicles include engine speed sensors, fuel consumption sensors, area counters or distance counters that interact with GPS or radar signals, PTO (power take-off) speed sensors, tractor hydraulics sensors configured to detect hydraulics parameters such as pressure or flow, and/or and hydraulic pump speed, wheel speed sensors or wheel slippage sensors. In an embodiment, examples of controllers 114 that may be used with tractors include hydraulic directional controllers, pressure controllers, and/or flow controllers; hydraulic pump speed controllers; speed controllers or governors; hitch position controllers; or wheel position controllers provide automatic steering.

In an embodiment, examples of sensors 112 that may be used with seed planting equipment such as planters, drills, or air seeders include seed sensors, which may be optical, electromagnetic, or impact sensors; downforce sensors such as load pins, load cells, pressure sensors; soil property sensors such as reflectivity sensors, moisture sensors, electrical conductivity sensors, optical residue sensors, or temperature sensors; component operating criteria sensors such as planting depth sensors, downforce cylinder pressure sensors, seed disc speed sensors, seed drive motor encoders, seed conveyor system speed sensors, or vacuum level sensors; or pesticide application sensors such as optical or other electromagnetic sensors, or impact sensors. In an embodiment, examples of controllers 114 that may be used with such seed planting equipment include: toolbar fold controllers, such as controllers for valves associated with hydraulic cylinders; downforce controllers, such as controllers for valves associated with pneumatic cylinders, airbags, or hydraulic cylinders, and programmed for applying downforce to individual row units or an entire planter frame; planting depth controllers, such as linear actuators; metering controllers, such as electric seed meter drive motors, hydraulic seed meter drive motors, or swath control clutches; hybrid selection controllers, such as seed meter drive motors, or other actuators programmed for selectively allowing or preventing seed or an air-seed mixture from delivering seed to or from seed meters or central bulk hoppers; metering controllers, such as electric seed meter drive motors, or hydraulic seed meter drive motors; seed conveyor system controllers, such as controllers for a belt seed delivery conveyor motor; marker controllers, such as a controller for a pneumatic or hydraulic actuator; or pesticide application rate controllers, such as metering drive controllers, orifice size or position controllers.

In an embodiment, examples of sensors 112 that may be used with tillage equipment include position sensors for tools such as shanks or discs; tool position sensors for such tools that are configured to detect depth, gang angle, or lateral spacing; downforce sensors; or draft force sensors. In an embodiment, examples of controllers 114 that may be used with tillage equipment include downforce controllers or tool position controllers, such as controllers configured to control tool depth, gang angle, or lateral spacing.

In an embodiment, examples of sensors 112 that may be used in relation to apparatus for applying fertilizer, insecticide, fungicide and the like, such as on-planter starter fertilizer systems, subsoil fertilizer applicators, or fertilizer sprayers, include: fluid system criteria sensors, such as flow sensors or pressure sensors; sensors indicating which spray head valves or fluid line valves are open; sensors associated with tanks, such as fill level sensors; sectional or system-wide supply line sensors, or row-specific supply line sensors; or kinematic sensors such as accelerometers disposed on sprayer booms. In an embodiment, examples of controllers 114 that may be used with such apparatus include pump speed controllers; valve controllers that are programmed to control pressure, flow, direction, PWM and the like; or position actuators, such as for boom height, subsoiler depth, or boom position.

In an embodiment, examples of sensors 112 that may be used with harvesters include yield monitors, such as impact plate strain gauges or position sensors, capacitive flow sensors, load sensors, weight sensors, or torque sensors associated with elevators or augers, or optical or other electromagnetic grain height sensors; grain moisture sensors, such as capacitive sensors; grain loss sensors, including impact, optical, or capacitive sensors; header operating criteria sensors such as header height, header type, deck plate gap, feeder speed, and reel speed sensors; separator operating criteria sensors, such as concave clearance, rotor speed, shoe clearance, or chaffer clearance sensors; auger sensors for position, operation, or speed; or engine speed sensors. In an embodiment, examples of controllers 114 that may be used with harvesters include header operating criteria controllers for elements such as header height, header type, deck plate gap, feeder speed, or reel speed; separator operating criteria controllers for features such as concave clearance, rotor speed, shoe clearance, or chaffer clearance; or controllers for auger position, operation, or speed.

In an embodiment, examples of sensors 112 that may be used with grain carts include weight sensors, or sensors for auger position, operation, or speed. In an embodiment, examples of controllers 114 that may be used with grain carts include controllers for auger position, operation, or speed.

In an embodiment, examples of sensors 112 and controllers 114 may be installed in unmanned aerial vehicle (UAV) apparatus or “drones.” Such sensors may include cameras with detectors effective for any range of the electromagnetic spectrum including visible light, infrared, ultraviolet, near-infrared (NIR), and the like; accelerometers; altimeters; temperature sensors; humidity sensors; pitot tube sensors or other airspeed or wind velocity sensors; battery life sensors; or radar emitters and reflected radar energy detection apparatus; other electromagnetic radiation emitters and reflected electromagnetic radiation detection apparatus. Such controllers may include guidance or motor control apparatus, control surface controllers, camera controllers, or controllers programmed to turn on, operate, obtain data from, manage and configure any of the foregoing sensors. Examples are disclosed in U.S. patent application Ser. No. 14/831,165 and the present disclosure assumes knowledge of that other patent disclosure.

In an embodiment, sensors 112 and controllers 114 may be affixed to soil sampling and measurement apparatus that is configured or programmed to sample soil and perform soil chemistry tests, soil moisture tests, and other tests pertaining to soil. For example, the apparatus disclosed in U.S. Pat. Nos. 8,767,194 and 8,712,148 may be used, and the present disclosure assumes knowledge of those patent disclosures.

In an embodiment, sensors 112 and controllers 114 may comprise weather devices for monitoring weather conditions of fields. For example, the apparatus disclosed in U.S. Provisional Application No. 62/154,207, filed on Apr. 29, 2015, U.S. Provisional Application No. 62/175,160, filed on Jun. 12, 2015, U.S. Provisional Application No. 62/198,060, filed on Jul. 28, 2015, and U.S. Provisional Application No. 62/220,852, filed on Sep. 18, 2015, may be used, and the present disclosure assumes knowledge of those patent disclosures.

2.4. Process Overview-Agronomic Model Training

In an embodiment, the agricultural intelligence computer system 130 is programmed or configured to create an agronomic model. In this context, an agronomic model is a data structure in memory of the agricultural intelligence computer system 130 that comprises field data 106, such as identification data and harvest data for one or more fields. The agronomic model may also comprise calculated agronomic properties which describe either conditions which may affect the growth of one or more crops on a field, or properties of the one or more crops, or both. Additionally, an agronomic model may comprise recommendations based on agronomic factors such as crop recommendations, irrigation recommendations, planting recommendations, fertilizer recommendations, fungicide recommendations, pesticide recommendations, harvesting recommendations and other crop management recommendations. The agronomic factors may also be used to estimate one or more crop related results, such as agronomic yield. The agronomic yield of a crop is an estimate of quantity of the crop that is produced, or in some examples the revenue or profit obtained from the produced crop.

In an embodiment, the agricultural intelligence computer system 130 may use a preconfigured agronomic model to calculate agronomic properties related to currently received location and crop information for one or more fields. The preconfigured agronomic model is based upon previously processed field data, including but not limited to, identification data, harvest data, fertilizer data, and weather data. The preconfigured agronomic model may have been cross validated to ensure accuracy of the model. Cross validation may include comparison to ground truthing that compares predicted results with actual results on a field, such as a comparison of precipitation estimate with a rain gauge or sensor providing weather data at the same or nearby location or an estimate of nitrogen content with a soil sample measurement.

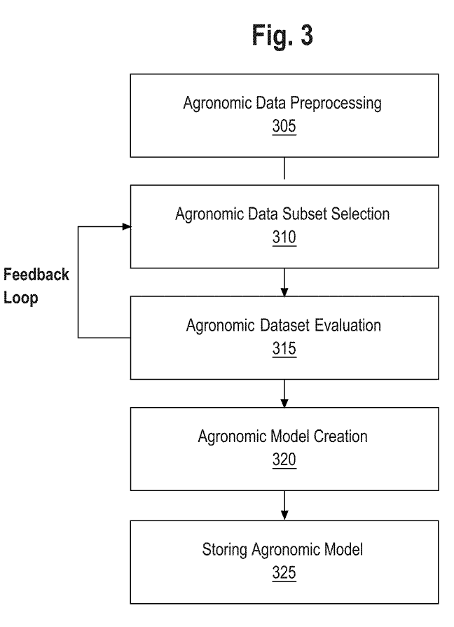

FIG. 3 illustrates a programmed process by which the agricultural intelligence computer system generates one or more preconfigured agronomic models using field data provided by one or more data sources. FIG. 3 may serve as an algorithm or instructions for programming the functional elements of the agricultural intelligence computer system 130 to perform the operations that are now described.

At block 305, the agricultural intelligence computer system 130 is configured or programmed to implement agronomic data preprocessing of field data received from one or more data sources. The field data received from one or more data sources may be preprocessed for the purpose of removing noise, distorting effects, and confounding factors within the agronomic data including measured outliers that could adversely affect received field data values. Embodiments of agronomic data preprocessing may include, but are not limited to, removing data values commonly associated with outlier data values, specific measured data points that are known to unnecessarily skew other data values, data smoothing, aggregation, or sampling techniques used to remove or reduce additive or multiplicative effects from noise, and other filtering or data derivation techniques used to provide clear distinctions between positive and negative data inputs.

At block 310, the agricultural intelligence computer system 130 is configured or programmed to perform data subset selection using the preprocessed field data in order to identify datasets useful for initial agronomic model generation. The agricultural intelligence computer system 130 may implement data subset selection techniques including, but not limited to, a genetic algorithm method, an all subset models method, a sequential search method, a stepwise regression method, a particle swarm optimization method, and an ant colony optimization method. For example, a genetic algorithm selection technique uses an adaptive heuristic search algorithm, based on evolutionary principles of natural selection and genetics, to determine and evaluate datasets within the preprocessed agronomic data.

At block 315, the agricultural intelligence computer system 130 is configured or programmed to implement field dataset evaluation. In an embodiment, a specific field dataset is evaluated by creating an agronomic model and using specific quality thresholds for the created agronomic model. Agronomic models may be compared and/or validated using one or more comparison techniques, such as, but not limited to, root mean square error with leave-one-out cross validation (RMSECV), mean absolute error, and mean percentage error. For example, RMSECV can cross validate agronomic models by comparing predicted agronomic property values created by the agronomic model against historical agronomic property values collected and analyzed. In an embodiment, the agronomic dataset evaluation logic is used as a feedback loop where agronomic datasets that do not meet configured quality thresholds are used during future data subset selection steps (block 310).

At block 320, the agricultural intelligence computer system 130 is configured or programmed to implement agronomic model creation based upon the cross validated agronomic datasets. In an embodiment, agronomic model creation may implement multivariate regression techniques to create preconfigured agronomic data models.

At block 325, the agricultural intelligence computer system 130 is configured or programmed to store the preconfigured agronomic data models for future field data evaluation.

2.5. Implementation Example-Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

For example, FIG. 4 is a block diagram that illustrates a computer system 400 upon which an embodiment of the invention may be implemented. Computer system 400 includes a bus 402 or other communication mechanism for communicating information, and a hardware processor 404 coupled with bus 402 for processing information. Hardware processor 404 may be, for example, a general purpose microprocessor.

Computer system 400 also includes a main memory 406, such as a random access memory (RAM) or other dynamic storage device, coupled to bus 402 for storing information and instructions to be executed by processor 404. Main memory 406 also may be used for storing temporary variables or other intermediate information during execution of instructions to be executed by processor 404. Such instructions, when stored in non-transitory storage media accessible to processor 404, render computer system 400 into a special-purpose machine that is customized to perform the operations specified in the instructions.

Computer system 400 further includes a read only memory (ROM) 408 or other static storage device coupled to bus 402 for storing static information and instructions for processor 404. A storage device 410, such as a magnetic disk, optical disk, or solid-state drive is provided and coupled to bus 402 for storing information and instructions.

Computer system 400 may be coupled via bus 402 to a display 412, such as a cathode ray tube (CRT), for displaying information to a computer user. An input device 414, including alphanumeric and other keys, is coupled to bus 402 for communicating information and command selections to processor 404. Another type of user input device is cursor control 416, such as a mouse, a trackball, or cursor direction keys for communicating direction information and command selections to processor 404 and for controlling cursor movement on display 412. This input device typically has two degrees of freedom in two axes, a first axis (e.g., x) and a second axis (e.g., y), that allows the device to specify positions in a plane.

Computer system 400 may implement the techniques described herein using customized hard-wired logic, one or more ASICs or FPGAs, firmware and/or program logic which in combination with the computer system causes or programs computer system 400 to be a special-purpose machine. According to one embodiment, the techniques herein are performed by computer system 400 in response to processor 404 executing one or more sequences of one or more instructions contained in main memory 406. Such instructions may be read into main memory 406 from another storage medium, such as storage device 410. Execution of the sequences of instructions contained in main memory 406 causes processor 404 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical disks, magnetic disks, or solid-state drives, such as storage device 410. Volatile media includes dynamic memory, such as main memory 406. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 402. Transmission media can also take the form of acoustic or light waves, such as those generated during radio-wave and infrared data communications.

Various forms of media may be involved in carrying one or more sequences of one or more instructions to processor 404 for execution. For example, the instructions may initially be carried on a magnetic disk or solid-state drive of a remote computer. The remote computer can load the instructions into its dynamic memory and send the instructions over a telephone line using a modem. A modem local to computer system 400 can receive the data on the telephone line and use an infra-red transmitter to convert the data to an infra-red signal. An infra-red detector can receive the data carried in the infrared signal and appropriate circuitry can place the data on bus 402. Bus 402 carries the data to main memory 406, from which processor 404 retrieves and executes the instructions. The instructions received by main memory 406 may optionally be stored on storage device 410 either before or after execution by processor 404.

Computer system 400 also includes a communication interface 418 coupled to bus 402. Communication interface 418 provides a two-way data communication coupling to a network link 420 that is connected to a local network 422. For example, communication interface 418 may be an integrated services digital network (ISDN) card, cable modem, satellite modem, or a modem to provide a data communication connection to a corresponding type of telephone line. As another example, communication interface 418 may be a local area network (LAN) card to provide a data communication connection to a compatible LAN. Wireless links may also be implemented. In any such implementation, communication interface 418 sends and receives electrical, electromagnetic or optical signals that carry digital data streams representing various types of information.

Network link 420 typically provides data communication through one or more networks to other data devices. For example, network link 420 may provide a connection through local network 422 to a host computer 424 or to data equipment operated by an Internet Service Provider (ISP) 426. ISP 426 in turn provides data communication services through the world wide packet data communication network now commonly referred to as the “Internet” 428. Local network 422 and Internet 428 both use electrical, electromagnetic or optical signals that carry digital data streams. The signals through the various networks and the signals on network link 420 and through communication interface 418, which carry the digital data to and from computer system 400, are example forms of transmission media.

Computer system 400 can send messages and receive data, including program code, through the network(s), network link 420 and communication interface 418. In the Internet example, a server 430 might transmit a requested code for an application program through Internet 428, ISP 426, local network 422 and communication interface 418.

The received code may be executed by processor 404 as it is received, and/or stored in storage device 410, or other non-volatile storage for later execution.

3.0 Sensor Wheel

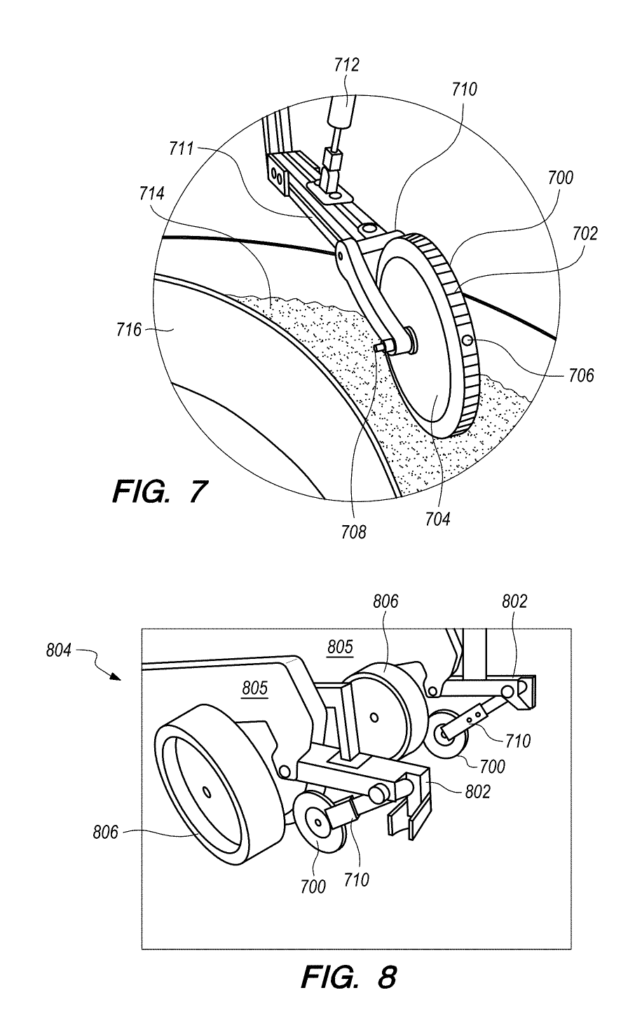

FIG. 7 illustrates a sensor wheel according to a first mounting arrangement.

In the example of FIG. 7, a sensor wheel 700 comprises a circumferential tread affixed to a hidden frame that is concealed by opposing circular covers 704. A plurality of sensors 706 are affixed to the frame and within the tread and comprise sensing elements that are directed outwardly and capable of direct contact with soil 714 in a trench 716. In the example of FIG. 7, trench 716 is an artificial trench constructed for testing or demonstration purposes but a field trench may be used with this or other embodiments. In some embodiments, wheel 700 rides on a rigid axle 708 that is affixed in a fork 710 having a distal bar 711 that is driven downwardly by a hydraulic or air-driven actuator 712 to provide downforce to urge the wheel against the soil surface to ensure good contact of sensors 706 with soil.

FIG. 8 illustrates a sensor wheel according to a second mounting arrangement. In the example of FIG. 8, two sensor wheels 700 are mounted via forks 710 to brackets 802 extending rearwardly from frame members 805 of a row unit 804 that rides in a row on closing wheels 806. In this arrangement, downforce on wheels 700 may be provided passively from the weight of the row unit, frame members 805 and wheels 806.

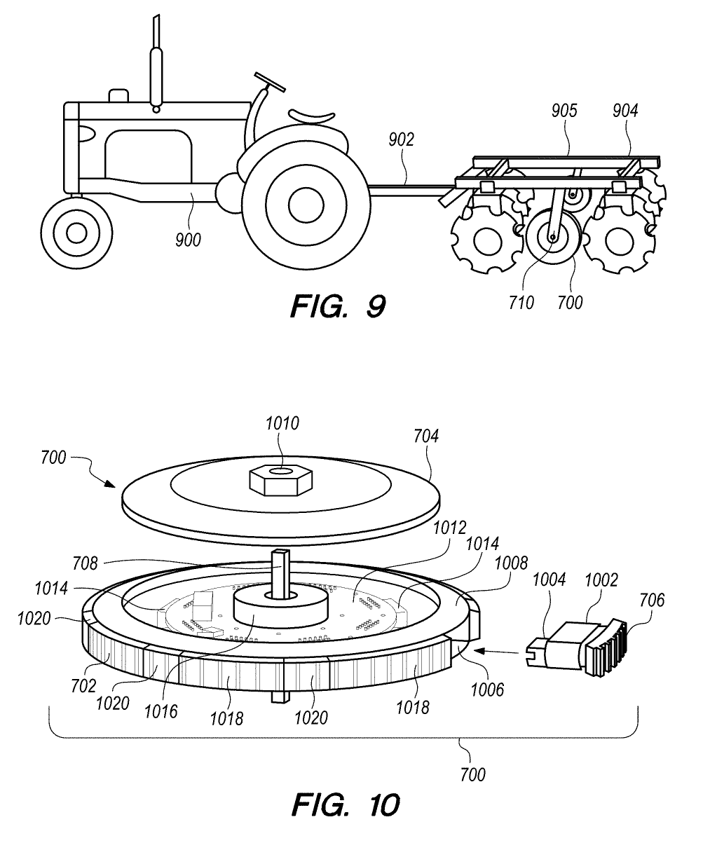

FIG. 9 illustrates a sensor wheel according to a third mounting arrangement. In the example of FIG. 9, a tractor 900 is coupled to using a fixed or hydraulic drawbar 802 or other implement coupling to an implement 904 having a frame 906 to which forks 710 are mounted. Downforce on wheels 700 may come passively from the weight of the implement 904, or from hydraulic actuators that are coupled between the frame 906 and forks 710. Implement 904 may comprise a disc plow, row unit, planter or any other soil-engaging implement. In one embodiment, wheel 700 is mounted to a row unit using a mounting plate adapter and contacts soil in a furrow behind cutting wheels just after seed is dropped in the furrow.

In any such embodiment, sensors 706 may be configured to detect any of a plurality different properties of soils. Examples include firmness, temperature, moisture, organic matter, solid material, conductivity, pH, cation exchange capacity (CEC)) and others. Further, an adapter may be used to affix wheel 700 to an implement axle in some embodiments, and axle 708 thus may be omitted in favor of an existing mounting on the implement. The adapter and/or axle 708 may incorporate indexing elements that permit installing the wheel 700 only in one orientation. Variable downforce can be applied using air cylinders, hydraulics or other actuators; pre-pressurized cylinders, spring-loaded actuators or other suspension mechanisms may be used in various embodiments.

Furthermore, in an embodiment, while a plurality of positions and receptacles for sensors 706 may be provided, a sensor is not required in every position or coupled to every connection. Instead, in an embodiment, a sensor wheel 700 may provide N positions and receptacles and a number of sensors 706 less than N may be installed, with all other sensor positions filled with non-active elements. Examples include dummy sensor modules, filler plates, caps or covers. In an embodiment, each such non-active element comprises as one element a segment of a tread 702 and fits snugly into a sensor position to provide a continuous tread and a closed, sealed environment for active electronics and mechanical elements within the wheel 700.

FIG. 10 is an exploded perspective view of a sensor wheel in a partly disassembled state. As with FIG. 7, wheel 700 comprises tread 702 and cover 704, and mounts to axle 708. The diameter of wheel 700 in this embodiment is about 6 in (15 cm), but other dimensions may be used and the specific size is not critical. The size of wheel 700 may be chosen based upon the application; for example, width of tread 702 and the overall width of wheel 700 over covers 704 may be selected to fit within a furrow or to ensure mounting compatibility with planter units of various manufacturers. Diameter may vary depending on the number of sensors; for example, a wheel 700 with four (4) sensors could be smaller in diameter than a wheel with eight (8) sensors of the same type. As diameter increases, corresponding changes in a mounting system may be needed.

Tread 702 is affixed to a frame ring 1008. A retaining ring 1016 rotates around axle 708 and retains a circuit board 1012 against the frame ring 1008 and a floor of the wheel (not shown in FIG. 10). The circuit board is generally structured as a planar ring that surrounds the retention ring 1016 and nests within a recess in the wheel interior formed between the covers 704 and frame ring 1008. Tread 702 is discontinuous and comprises a first set of arcuate tread segments 1018 that are affixed to discontinuous portions of an outer rim or outer circumferential surface of the frame ring 1008 and constitute a portion of a soil contacting bearing surface when the wheel 700 is in contact with soil.

Tread 702 further comprises a plurality of arcuate removable tread segments 1020 that cover a plurality of corresponding recesses 706 in frame ring 1008. Tread segments 1020 are integrally formed with sensors 706 and are configured to mount in a recess 1006 such that tread segments 1020 are aligned with tread segment 1018 to form a continuous tread on a outer circumference of the wheel 700.

Each recess 1006 is configured to receive a removable sensor 706, which may comprise a sensor body 1002 and plug 1004 that mates to a corresponding socket 1014 of circuit board 1012. When these parts are assembled, each socket 1014 and recess 1006 is radially aligned to permit plug installation of sensor 706 by sliding the sensor body 1002 into the recess 1006 and mating the plug 1004 to the socket. Furthermore, insertion of a sensor 706 into the wheel 700 in this manner forms a closed seal to prevent penetration of soil or moisture into an interior of the wheel.

Various embodiments may provide any number of sockets 1014, recesses 1006 and sensors 706; counts of one to eight sensors may be used in some embodiments. When multiple sensors 706 are used, each sensor may be structured mechanically, electrically and/or chemically to sense or detect a different property of soil. Or, multiple sensors may be configured to sense the same property for purposes of redundancy, cross-validation of data and/or fault protection. Furthermore, each recess 1006 among one or more of the recesses 1006 may receive a non-active element such as a dummy sensor module, filler plate, cap or cover. Each such non-active element may comprise as one element a segment of tread 702 that fits snugly into a recess 1006 to provide a continuous tread and a closed, sealed environment for active electronics and mechanical elements within the wheel 700.

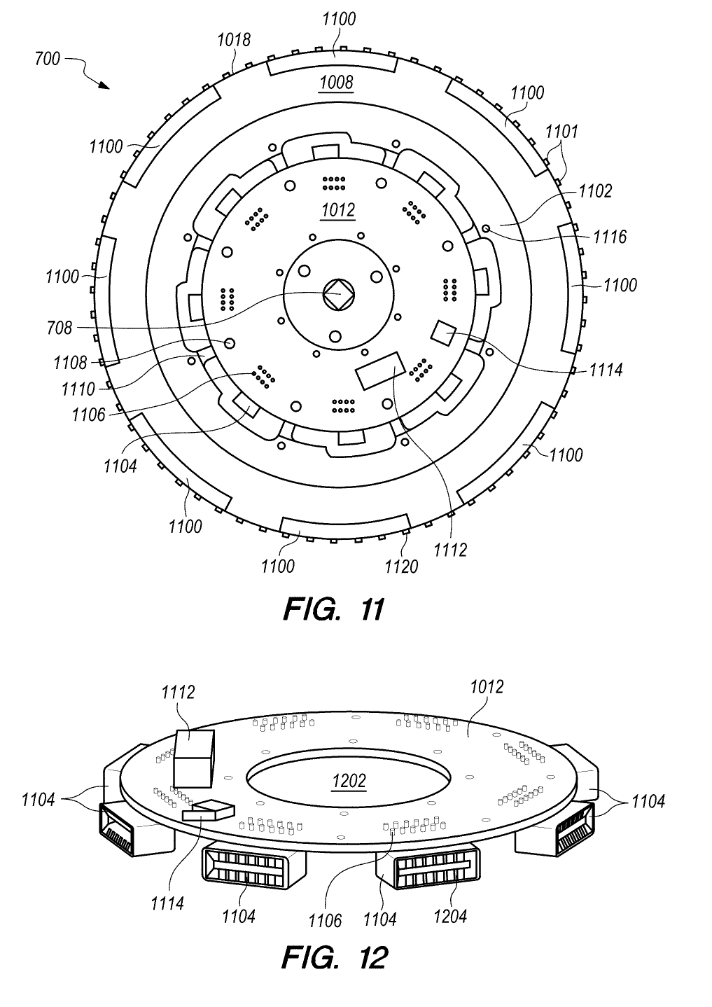

FIG. 11 illustrates a bottom plan view of a wheel in an embodiment similar to that seen in FIG. 10 and showing details of an underside of a circuit board and related components.

In the example of FIG. 11, a plurality of removable tread segments 1100 are arranged in spaced-apart positions around a circumference of the wheel. Eight (8) removable tread segments 1100 are provided in this embodiment but other embodiments may have any number, typically from one to 12. Each segment 1100 comprises a plurality of upstanding or outwardly facing tread points 1101 that function to improve traction on soil when the wheel 700 rotates. The use of tread points 1101 is not required, however, and the tread 702 and segments 1018, 1020 may be smooth in any embodiment described in this disclosure.

Wheel 700 further comprises an inner frame ring 1102 that is located within the first frame ring 1008; the inner frame ring may be formed of a material that is the same as, or compatible with, the removable tread segments 1100 and includes recesses to snugly retain the removable tread segments in place. In one embodiment, removable tread segments 1100 and inner frame ring 1102 comprise white nylon but other polymers, metals or composites can be used in other embodiments.

Circuit board 1012 comprises a plurality of spaced-apart, radially aligned receptacles 1104, which may comprise integrally L-formed, board-mount dual in-line pin (DIP) elements 1106. In this arrangement, receptacles 1104 may be affixed to the circuit board 1012 by soldering the DIP elements 1106 into the board. The example of FIG. 11 shows 8-pin DIP receptacles, but any number of pins may be used, depending upon the type of receptacles 1104 and the number of electrical contacts that are needed for particular applications. Each of the receptacles 1104 faces outwardly toward one of the recesses 1006 (FIG. 10) that is exposed when a removable tread segment 1100 is removed. In this position, receptacles 1104 are arranged to receive mating plug portions of sensors 706 when the sensors are inserted into the recesses.

Circuit board 1012 may comprise a plurality of spaced-apart holes 1108 that receive fasteners such as machine screws to affix the circuit board to inwardly protruding arms 1110 that are formed integrally with or fastened to either the inner frame ring 1102 or the first frame ring 1008. The arms 1110 may be fastened to the inner frame ring 1102 using rivets. Or, the arms 1110 may comprise metal such as aluminum or steel and may be thermally bonded by heating the arms above a melting temperature of a polymer of the inner frame ring 1102 and applying pressure to impress the arms into the inner frame ring. The fastening may be facilitated using a plurality of spaced-apart holes 1116 in the inner frame ring 1102 that receive thermally bonded corresponding upstanding bosses on the arms 1110 or that receive fasteners such as rivets or screws.

In an embodiment, circuit board 1012 further comprises a testing connector 1112 that is soldered into the board and electrically provides contact points for applying power, reading data or communicating program instructions to the circuit board. For example, a wheel 700 may be dismounted from an implement, brought to a testing location and connected to a computer or other testing apparatus using testing connector 1112. In one embodiment, circuit board 1012 further comprises a microswitch 1114 that is configured to close when the wheel 700 is fully assembled, under gentle pressure from a compression element within one of the covers 704, and to open when the cover is removed. The microswitch 1114 may be electrically coupled in series with a battery power supply for the active electronic elements of the wheel 700. In this manner, battery power is removed automatically when the wheel 700 is disassembled and power is applied only when a cover 704 is affixed, thereby saving battery power for use only when the wheel is assembled for mounting and operation.

FIG. 12 is a perspective view of a circuit board in an embodiment that is similar to the circuit board of FIG. 11. In an embodiment, circuit board 1012 of FIG. 12 comprises a plurality of radially aligned, spaced-apart receptacles 1104 that are configured to mate to compatible plugs 1004 (FIG. 10) of sensors 706. This arrangement permits removal and replacement of sensors 706 at any time prior to use of the wheel 700, as well as the introduction of different sensors that are developed in the future. Each of the receptacles 1104 may be soldered into the circuit board 1012 using L-formed dual in-line pin (DIP) elements 1106. An example arrangement of testing connector 1112 and microswitch 1114 on circuit board 1012 also are shown in FIG. 12. In an embodiment, circuit board 1012 may further comprise a central circular hold 1202 to permit mounting over the axle 708 and ring 1016 of the wheel (FIG. 10).

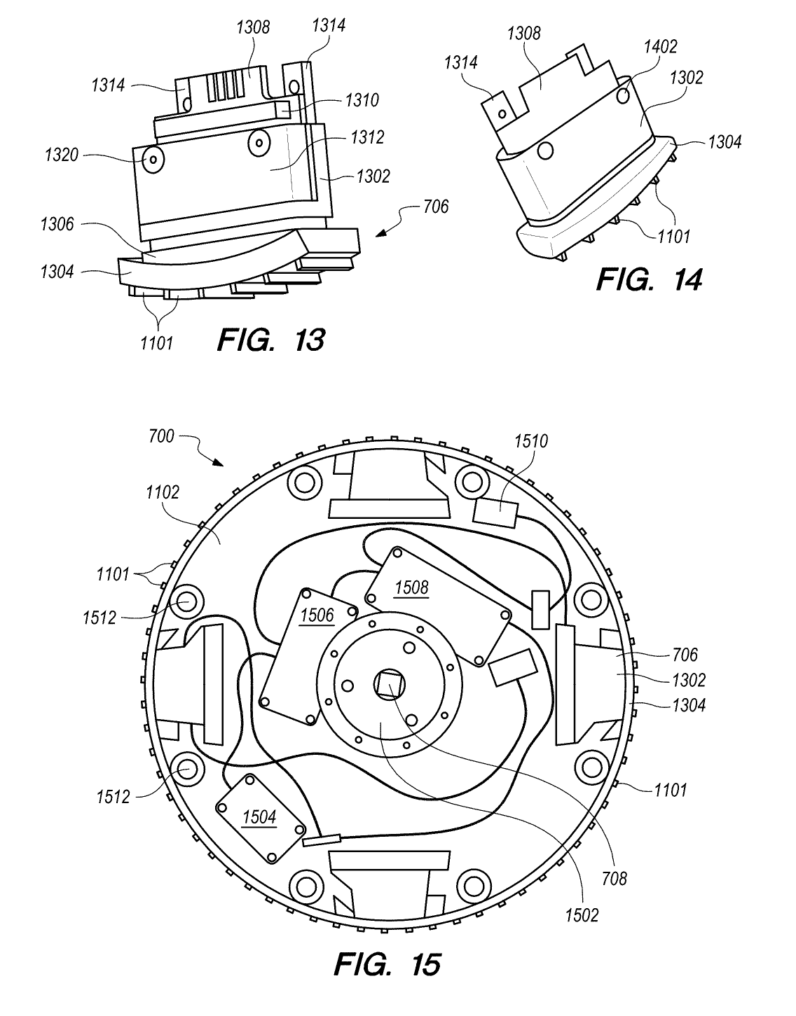

FIG. 13 is a top perspective view of an example sensor. FIG. 14 is a bottom perspective view of the example sensor of FIG. 13.

Referring first to FIG. 13, a sensor 706 comprises a sensor body 1302 generally formed as a stepped, rounded rectangular polyhedron affixed to, or integrally formed with, an arcuate tread segment 1304 having a plurality of outwardly or upstanding spaced apart tread elements 1101. Tread segment 1304 transitions to the sensor body 1302 using a part arcuate attachment section 1306. Sensor body 1302 further comprises two or more rearwardly extending arms 1314 that are integrally formed with the sensor body, and may feature holes to receive fasteners to secure the sensor body within the wheel 700; additionally or alternatively, the arms may include distal bosses or other protrusions that engage corresponding recesses in the frame elements of the wheel to snugly retain the sensor body in the wheel frame via friction. These elements may be formed of polystyrene, ABS plastic, other polymers, or metals.

Sensor body 1302 and/or tread segment 1304 may incorporate a window or orifice, with or without a transparent, translucent or conductive surface, to interface active electronic or electro-chemical elements within the sensor body to soils. For example, a germanium window may be used between certain kinds of temperature sensors and soil, to permit more accurate detection of soil temperature without permitting actual contact of soil to the sensor's active elements.

In an embodiment, a printed circuit edge connector 1308 is affixed to the sensor body 1302 and shielded by a removable shield unit 1312. Edge connector 1308 comprises conductive contact elements in a portion of the edge connector that is disposed between the arms 1314 and that is capable of mating to one of the receptacles 1104 in wheel 700. Edge connector 1308 may comprise an elongated lateral stop block 1314 to limit the depth to which the edge connector is seated in a receptacle 1104 and protect active elements located under the shield unit 1312. Sensing elements such as active electronic circuitry, mechanical sensors, photo sensors or pairs of light sources and photodetectors, and/or chemical sensors may be affixed to the edge connector 1308 using soldered printed circuit board mounting techniques or other securing methods. Each sensor 706 may comprise specific sensing elements, EPROM or other non-volatile storage for identifying values and/or type values of a particular sensor, and other elements.

These components typically are protected within a housing formed by shield unit 1312 over sensor body 1302. The shield unit 1312 may comprise fasteners 1320 that permit removal of the shield unit to access or service components that are protected by the shield. Fasteners 1320 may extend through the sensor body 1302 and terminate in heads 1402 (FIG. 14). Screws may be used, for example. Components on the edge connector 1308 may include elements that extend through holes or orifices in the tread segment 1304 to achieve direct soil contact when the wheel 700 is assembled and placed in use. Furthermore, insertion of a sensor 706 into the wheel 700 in this manner forms a closed seal to prevent penetration of soil or moisture into an interior of the wheel and to protect the edge connector 1308 and any active circuitry within the sensor body 1302.

FIG. 15 is a bottom plan view of a sensor wheel in another embodiment with a cover removed and showing an opposite orientation from FIG. 11. In the example of FIG. 15, inner frame ring 1102 (FIG. 11) forms a solid planar disk or floor surrounding axle 708 and a bearing ring 1502. Inner frame ring 1102 may comprise a plurality of spaced-apart fastener holes that are disposed around a circumference of the frame ring to receive matching lugs on a cover 704 to conceal the inner components shown in FIG. 15. In an embodiment, wheel 700 comprises one or more active electronic elements 1504, 1506, 1508 that may comprise a battery power supply, central processing unit (CPU) or microcontroller, memory such as EPROM or other storage, and a wireless networking telecommunications interface. One or more signal and power wires may terminate in connectors 1510 for purposes of testing or connection to other elements. The example of FIG. 15 further shows four (4) removable sensors 706 mounted in spaced-apart locations around the circumference of the wheel 702 and having the same elements as described herein for FIG. 13.

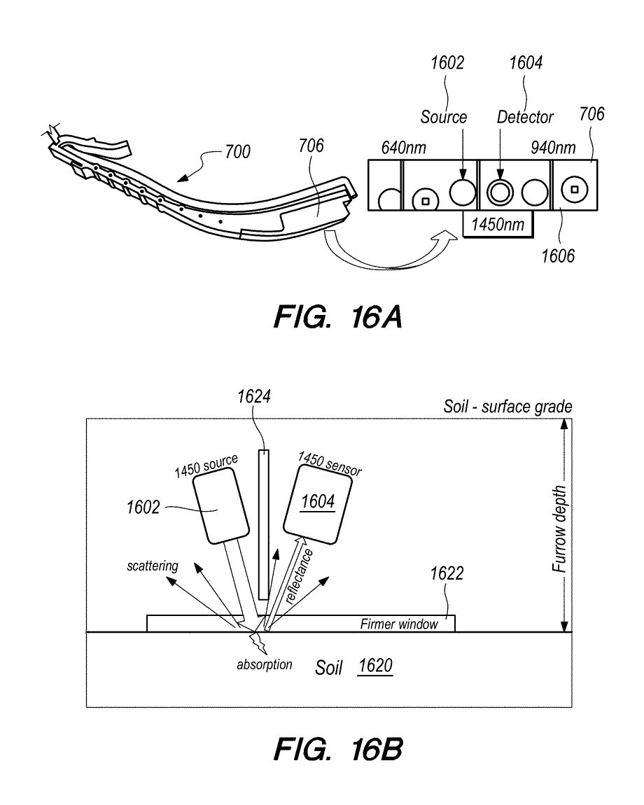

FIG. 16A is a schematic illustration of elements of a sensor. FIG. 16B illustrates light paths of an optical sensor in relation to a furrow in soil. Referring first to FIG. 16A, in an embodiment, a sensor 706 of a wheel 700 comprises an optical source 1602 and optical detector 1604 affixed in a housing 1606 at angles to permit light emitted from the optical source 1602 to reflect off soil for detection using optical detector 1604. In an embodiment, source 1602 and detector 1604 comprise a light-emitting diode (LED) and phototransistor. Various embodiments may use sources and detectors for light in a range of wavelengths; 640 nm, 940 nm, and 1450 nm have been used in some example embodiments. Sensors of other types may use different active circuitry; for example, infrared temperature sensors may be used, load cells may be used for firmness sensing or accelerometers having resistive films could be used.

Turning now to FIG. 16B, in operation in one embodiment, for moisture detection, source 1602 emits 1450 nm near-infrared light downward toward soil 1620 at a moment at which wheel 700 is resting on the soil and a sensor 706 that contains source 1602, detector 1604 is in soil contact. The soil 1602 may represent a floor of a furrow having a depth as indicated by the drawing figure and below a surface grade. Portions of light emitted from source 1602 are detected at detector 1604 based upon reflectance from soil 1620. Other light is lost via scattering or absorption into soil 1620. Under program control using a CPU or microcontroller in the wheel 700, or in the computer elements previously described in connection with FIG. 1, a level of detected light at detector 1604 may be transformed using a computational algorithm or a lookup table to determine an approximate thickness of a firmer window 1622 of the soil 1620. This data in turn may be used to drive decisions relating to control of an implement to which the wheel 700 is mounted, such as implement 904 of FIG. 9.

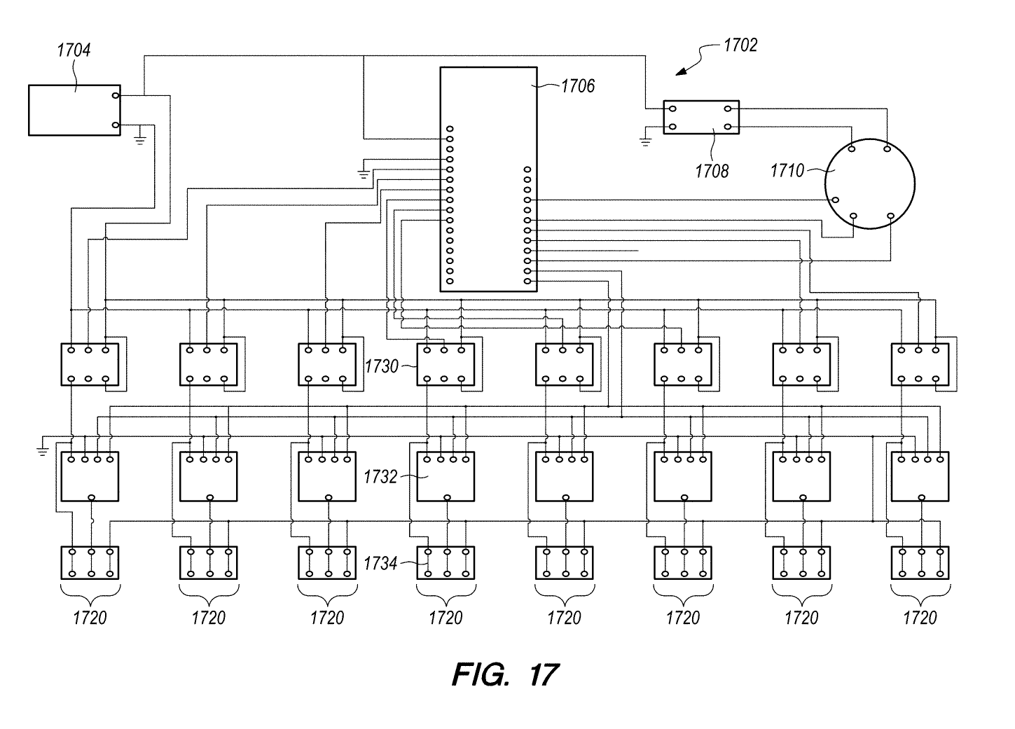

FIG. 17 is a schematic diagram of circuitry that may be used within a soil-contacting wheel having a plurality of removable sensors, in one embodiment. In the example of FIG. 17, circuit 1702 comprises components capable of installation on circuit board 1012 for mounting within a wheel 700. In an embodiment, circuit 1702 comprises a battery 1704 or other power source, typically at the 3.3 VDC or 5 VDC level for operation with TTL logic. A long-lasting chargeable or non-chargeable battery may be used. Battery 1704 is coupled to photo board 1706 which may comprise a microcontroller with firmware for stored program control of data capture functions. Battery 1704, when having 3.3 VDC or other low-voltage output, also may be coupled to a DC-DC converter 1708 that is configured to provide 5 VDC output to drive other elements.

In an embodiment, encoder 1710 is coupled to the DC-DC converter 1708 and functions to encode rotation of the wheel 700 to permit photo board 1706 to determine which of a plurality of sensors 706 is then-currently in soil contact. Encoder 1710 may comprise an absolute encoder of angular or rotational position. Output from the encoder 1710 can comprise signals used for clocking or latching sensors 706 on and off via switches.

In an embodiment, battery 1704 and photo board 1706 are coupled to a plurality of sub circuits 1720 each of which is associated with a different one of a plurality of the sensors 706. In the example of FIG. 17, eight (8) sub circuits 1720 are provided to interoperate with eight (8) sensors 706. Each sub circuit 1720 comprises a switch circuit 1730, an analog-to-digital converter 1732, and a plug 1734 that is compatible with a removable sensor 706. For example, photo board 1706 is first coupled to a Texas Instruments SN74LVC1G3157 single-pole, double-throw analog switch, which is coupled in turn to Microchip Inc. MCP3221 successive approximation A/D converter and to a plug. Pins of plug 1734 comprise supply voltage, ground and an analog input in one embodiment; other embodiments may include pins to obtain sensor identifying data, expansion usage or other purposes. The A/D converter 1732 may have different resolution and sampling rates in various embodiments; in one embodiment, an A/D converter with 12-bit resolution and a 1.6 KHz sampling rate is used.

In this arrangement, under program control, the photo board 1706 receives input from encoder 1710 indicating a current angular position of the wheel 700. The physical angular position of each of the sensors 706 is fixed and known; therefore, input from encoder 1710 may be transformed under program control into an identification of one of the eight (8) sensors 706 that is then currently in soil contact. The photo board 1706 signals a selected switch 1730 for the correct sensor 706 that has been identified and selected, thereby causing the switch to latch output of the A/D converter 1732 to a data line of the circuit 1702 and receive digitized data based upon analog input from sensor plug 1734. In other words, the A/D converter 1732 and plug 1734 are always powered and sensors 706 always are active, but switch 1730 functions to selectively provide sensor data to the CPU during a specified period as indicated by the encoder 1710 during which a particular sensor 706 is passing through an angular range that is associated with soil contact.

After a specified period corresponding to a period during which the selected sensor is in soil contact, and as the wheel 700 rotates, the photo board 1706 signals the selected switch 1730 to turn off the selected sensor, selects a different sensor that is now in soil contact, and signals the switch for that new sensor to turn on. The foregoing process repeats continuously as the wheel 700 is in motion. The duty cycle of the sensors 706 may be determined based upon detecting a rotational speed of the wheel 700 based on input data from encoder 1710 and algorithmic transformations programmed in photo board 1706. Typical rotational speeds are in the range of 1 mph to 10 mph.

Circuit 1702 further comprises, in one embodiment, wireless networking circuits such as a WiFi module, Bluetooth module or other short-range wireless networking infrastructure. In some embodiments, a Bluetooth module is used and configured to pair automatically with a compatible Bluetooth transceiver in a tractor cab or other location within wireless communication range of the wheel 700. Elements of FIG. 1 as discussed above then may relay digital data from sensors or the photo board 1706 to cloud computing elements or other networked server computing elements for remote data analysis.

In some embodiments, circuit 1702 or circuit board 1012 comprise a Global Positioning System (GPS) receiver that is capable of wireless detection of satellite GPS signals, performing location triangulation and determining a latitude-longitude (lat-long) geophysical position of the wheel 700. GPS location data obtained by the wheel 700 in this manner may be attached to each dataset or data element that the wheel transmits to a tractor cab computer or other host computer. Furthermore, circuit 1702 or circuit board 1012 may comprise a real-time clock and programmed algorithms that attach a date-time stamp value to each dataset or data element that the wheel transmits to a tractor cab computer or other host computer. In this manner, data from sensors 706 may be tagged with GPS location values and timestamp values before transmission to a host computer, for use in analysis of the data at the host computer. In other embodiments, GPS and clock elements may be in the cab computer or host computer, so that GPS location values and timestamp values are added at the host computer, rather than at the wheel 700.

Photo board 1706 also may be programmed to perform automatic identification of the type of sensor 706 that is coupled to each of the sensor plugs 1734. In an embodiment, photo board 1706 is programmed to detect initial application of power to the wheel 700 (power-up) and, in response, to enter a configuration cycle or loop to read sensor identification signals from sensor identification lines of each sensor 706 in turn until all available sensors have been read. For example, EPROM chips of each sensor 706 may be addressed and read to obtain identification values for each sensor position in the wheel 700. The identification signals may be mapped under program control to specified different sensor type values, which are transmitted to the host computer. Consequently, the host computer acquires messages specifying a total number of sensors, physical positions or receptacle position values (for example, positions one through eight), and type identifiers for each sensor in the wheel 700. This data may be transmitted with a serial number or other identifier of the wheel 700 as a whole, which may be hard-coded in firmware, EPROM or other memory of the wheel.

In an embodiment, because a sensor 706 is not required in every position or coupled to every connection, the photo board 1706 may be programmed to determine that no signal is received from a channel associated with a particular sensor position and to record that no sensor is installed in that position. For example, a query signal may be transmitted to each sensor plug 1734 and the photo board 1706 may be programmed to wait a specified period, such as 1 second, for a response from a sensor coupled to that particular plug. If no reply signal or identification signal is received before the end of the specified period, the photo board 1706 may be programmed to determine that the specified period has ended without receiving the one or more identification signals and, in response thereto, to store a vacant position value in association with a receptacle position value corresponding to a physical position of the first receptacle and indicating that the physical position of the first receptacle is vacant.

In an embodiment, the data conditioning instructions 136 may comprise a set of pages in RAM that contain instructions which when executed cause performing obtaining raw sensor data from a sensor wheel 700 as further described herein, filtering or transforming the data to remove noise, anomalies or outlier values, and updating repository 160 with filtered or improved data from the sensor wheel. The specific processing that is performed to transform data may vary depending on the sensor 706 from which raw data originated. For example, moisture sensor data is known to be highly affected by ambient light and the data conditioning instructions 136 may be programmed to perform pattern recognition to determine whether certain values or sets of values reflect error based on the presence of sunlight on the sensor.

What is claimed is:

1. Apparatus for sensing soil characteristics, comprising:
a circular wheel frame that is capable of rotation in an agricultural field;
at least one first arcuate tread segment that is affixed to an outer rim of the wheel frame and constitutes a soil contacting bearing surface when the apparatus is in contact with soil;
at least one recess in the outer rim of the wheel frame;
a circuit board within the wheel frame and having at least a first receptacle that is radially aligned with the at least one recesses;
at least one removable sensor comprising one or more first sensing elements, a first plug that mates to the first receptacle of the circuit board, and a second arcuate tread segment and configured to mount in the at least one recess with the second arcuate tread segment aligned with the first arcuate tread segment to form a continuous tread;
a power supply coupled to the at least one removable sensor through the connector;
means coupled to the power supply for wirelessly transmitting data obtained from the at least one removable sensor to a host computer that is separate from the apparatus.

2. The apparatus of claim 1, further comprising means for mounting the apparatus on an agricultural implement in which the wheel frame is capable of rotating in contact with soil as the implement is moved in the field.

3. The apparatus of claim 2, wherein the means for mounting further comprises means for exerting downforce on the wheel frame as the implement is moved in the field.

4. The apparatus of claim 1, further comprising:
at least a second removable sensor comprising one or more second sensing elements, a second plug that mates to a second receptacle of the circuit board, and a third arcuate tread segment and configured to mount in a second recess of the wheel frame with the third arcuate tread segment aligned with the first arcuate tread segment to form a continuous tread;
wherein the first sensing elements and the second sensing elements are configured to sense different characteristics of soil.

5. The apparatus of claim 4, wherein the characteristics are any of moisture, firmness, pH, temperature, organic matter content, solid material content, conductivity, or cation exchange capacity (CEC)).

6. The apparatus of claim 1, wherein the first sensing elements comprise a 1450 nm light source and a 1450 nm light detector.

7. The apparatus of claim 1, wherein the circuit board comprises a continuous planar ring mounted within the wheel frame.

8. The apparatus of claim 1, further comprising:
at least one second recess in the outer rim of the wheel frame;
a dummy sensor module, filler plate, cap or cover comprising at least a third arcuate tread segment and configured to mount in the at least one second recess with the third arcuate tread segment aligned with the first arcuate tread segment to form a continuous tread.

9. The apparatus of claim 1, further comprising:
an encoder that is coupled to the power supply and configured to continuously detect an angular amount of rotation of the wheel frame and to signal a photo board using a rotation data signal representative of the angular amount of rotation;
a switch coupled between the photo board and an analog-to-digital converter, the analog-to-digital converter coupled to the first receptacle;
a microcontroller comprising a stored control program that is configured to cause the microcontroller to respond to the rotation data signal and to signal the switch to obtain sensor data from the at least one sensor via the analog-to-digital converter only when the rotation data signal indicates that the at least one sensor is within a range of angular values that are associated with soil contact.

10. The apparatus of claim 8, wherein the stored control program is configured to cause the microcontroller to transmit the sensor data to the host computer, via the means for wirelessly transmitting, only when the rotation data signal indicates that the at least one sensor is within a range of angular values that are associated with soil contact.

11. The apparatus of claim 1, further comprising:
a microcontroller coupled to the power supply, to the means for wirelessly transmitting, and to the at least one removable sensor, and to a global positioning system (GPS) receiver;
the microcontroller comprising a stored control program that is configured to cause the microcontroller to automatically determine position values for a then-current geophysical position of the wheel using the GPS receiver, and to automatically add the position values to the sensor data prior to transmission to the host computer.

12. The apparatus of claim 1, further comprising:
a microcontroller coupled to the power supply, to the means for wirelessly transmitting, and to the at least one removable sensor;
the microcontroller comprising a stored control program that is configured to cause the microcontroller to send a query signal to the at least one removable sensor, to wait a specified period for one or more identification signals, and when the one or more identification signals are received, to determine a sensor type value indicating a sensor type of the at least one removable sensor based on the one or more identification signals, and to store the sensor type value in association with a receptacle position value corresponding to a physical position of the first receptacle.

13. The apparatus of claim 1, wherein the stored control program is further configured to determine that the specified period has ended without receiving the one or more identification signals and, in response thereto, to store a vacant position value in association with a receptacle position value corresponding to a physical position of the first receptacle and indicating that the physical position of the first receptacle is vacant.

14. The apparatus of claim 1, further comprising:
in addition to the at least one removable sensor, two (2) or more other removable sensors each comprising one or more second sensing elements, a second plug that mates to a second receptacle of the circuit board, and a third arcuate tread segment and configured to mount in a second recess of the wheel frame with the third arcuate tread segment aligned with the first arcuate tread segment to form a continuous tread;
wherein the first sensing elements and the second sensing elements are configured to sense different characteristics of soil;
wherein the second sensing elements of each of the two (2) or more other removable sensors are configured to sense same characteristics of soil;
wherein the characteristics are any of moisture, firmness, pH, temperature, organic matter content, solid material content, conductivity, or cation exchange capacity (CEC)).

15. A computer system for sensing soil characteristics, comprising:
a multi-sensor wheel comprising:
a circular wheel frame that is capable of rotation in an agricultural field;
at least one first arcuate tread segment that is affixed to an outer rim of the wheel frame and constitutes a soil contacting bearing surface when the apparatus is in contact with soil;
at least one recess in the outer rim of the wheel frame;
a circuit board within the wheel frame and having at least a first receptacle that is radially aligned with the at least one recesses;
at least one removable sensor comprising one or more first sensing elements, a first plug that mates to the first receptacle of the circuit board, and a second arcuate tread segment and configured to mount in the at least one recess with the second arcuate tread segment aligned with the first arcuate tread segment to form a continuous tread;
at least a second removable sensor comprising one or more second sensing elements, a second plug that mates to a second receptacle of the circuit board, and a third arcuate tread segment and configured to mount in a second recess of the wheel frame with the third arcuate tread segment aligned with the first arcuate tread segment to form a continuous tread;
wherein the first sensing elements and the second sensing elements are configured to sense different characteristics of soil;
a power supply coupled to the at least one removable sensor through the connector; and
means coupled to the power supply for wirelessly transmitting sensor data obtained from the at least one removable sensor;
a host computer that is separate from the apparatus and configured to wirelessly connect to the multi-sensor wheel and to receive the sensor data.

16. The apparatus of claim 15, further comprising means for mounting the multi-sensor wheel on an agricultural implement in which the wheel frame is capable of rotating in contact with soil as the implement is moved in the field.

17. The apparatus of claim 15, wherein the characteristics are any of moisture, firmness, pH, temperature, organic matter content, solid material content, conductivity, or cation exchange capacity (CEC)).

18. The apparatus of claim 15, further comprising:
at least one second recess in the outer rim of the wheel frame;
a dummy sensor module, filler plate, cap or cover comprising at least a third arcuate tread segment and configured to mount in the at least one second recess with the third arcuate tread segment aligned with the first arcuate tread segment to form a continuous tread.

19. The apparatus of claim 15, further comprising:
an encoder that is coupled to the power supply and configured to continuously detect an angular amount of rotation of the wheel frame and to signal a photo board using a rotation data signal representative of the angular amount of rotation;
a switch coupled between the photo board and an analog-to-digital converter, the analog-to-digital converter coupled to the first receptacle;
a microcontroller comprising a stored control program that is configured to cause the microcontroller to respond to the rotation data signal and to signal the switch to obtain sensor data from the at least one sensor via the analog-to-digital converter only when the rotation data signal indicates that the at least one sensor is within a range of angular values that are associated with soil contact.

20. The apparatus of claim 19, wherein the stored control program is configured to cause the microcontroller to transmit the sensor data to the host computer, via the means for wirelessly transmitting, only when the rotation data signal indicates that the at least one sensor is within a range of angular values that are associated with soil contact.

21. The apparatus of claim 15, further comprising:
a microcontroller coupled to the power supply, to the means for wirelessly transmitting, and to the at least one removable sensor, and to a global positioning system (GPS) receiver;
the microcontroller comprising a stored control program that is configured to cause the microcontroller to automatically determine position values for a then-current geophysical position of the wheel using the GPS receiver, and to automatically add the position values to the sensor data prior to transmission to the host computer.

22. The apparatus of claim 15, further comprising:
a microcontroller coupled to the power supply, to the means for wirelessly transmitting, and to the at least one removable sensor;
the microcontroller comprising a stored control program that is configured to cause the microcontroller to send a query signal to the at least one removable sensor, to wait a specified period for one or more identification signals, and when the one or more identification signals are received, to determine a sensor type value indicating a sensor type of the at least one removable sensor based on the one or more identification signals, and to store the sensor type value in association with a receptacle position value corresponding to a physical position of the first receptacle.

23. The apparatus of claim 15, wherein the stored control program is further configured to determine that the specified period has ended without receiving the one or more identification signals and, in response thereto, to store a vacant position value in association with a receptacle position value corresponding to a physical position of the first receptacle and indicating that the physical position of the first receptacle is vacant.

24. The apparatus of claim 15, further comprising:
in addition to the at least one removable sensor, two (2) or more other removable sensors each comprising one or more second sensing elements, a second plug that mates to a second receptacle of the circuit board, and a third arcuate tread segment and configured to mount in a second recess of the wheel frame with the third arcuate tread segment aligned with the first arcuate tread segment to form a continuous tread;
wherein the first sensing elements and the second sensing elements are configured to sense different characteristics of soil;
wherein the second sensing elements of each of the two (2) or more other removable sensors are configured to sense same characteristics of soil;
wherein the characteristics are any of moisture, firmness, pH, temperature, organic matter content, solid material content, conductivity, or cation exchange capacity (CEC)).
